(19) United States
(12) Patent Application Publication
(10) Pub. No.: US 2011/0117971 A1
(43) Pub. Date: May 19, 2011

(54) METHOD AND APPARATUS FOR OPERATING MOBILE TERMINAL HAVING AT LEAST TWO DISPLAY UNITS

(75) Inventors: Seok Tae KIM, Seoul (KR); Dong Seok RYU, Seoul (KR); Min Jeong KWON, Seoul (KR); Byung Soo KIM, Hwaseong-si (KR)

(73) Assignee: SAMSUNG ELECTRONICS CO. LTD., Suwon-si (KR)

(21) Appl. No.: 12/945,017

(22) Filed: Nov. 12, 2010

(30) Foreign Application Priority Data
Nov. 18, 2009 (KR) 10-2009-0111203

(51) Int. Cl. H04B 1/38

(52) U.S. Cl. 455/566

(57) ABSTRACT

A method and apparatus for operating a mobile terminal having two or more display units are provided. Display of screen data and function execution are performed through coordinated operations of the display units. The method includes displaying screen data of an electronic document on a first display according to a user request, transforming, upon detection of a mode transition interaction, the screen data of the electronic document displayed on the first display, and displaying the transformed screen data of the electronic document on a second display.

### PRIORITY

This application claims the benefit under 35 U.S.C. §119(a) of a Korean patent application filed on Nov. 18, 2009 in the Korean Intellectual Property Office and assigned Serial No. 10-2009-0111203, the entire disclosure of which is hereby incorporated by reference.

### BACKGROUND OF THE INVENTION

1. Field of the Invention

The present invention relates to a mobile terminal and operation method for the same. More particularly, the present invention relates to a mobile terminal having at least two display units and an operation method for the same wherein screen data display is controlled by coordinated operations of the display units.

2. Description of the Related Art

With rapid advances in electronics technology, mobile terminals are being equipped with increasingly diverse functions. A newly developed mobile terminal may provide various functions and user interface (UI) features for a user's convenience. The user interface is employed to enable the user to conveniently utilize a mobile terminal. User interface features have been developed to provide information to users in a rapid and intuitive manner in various circumstances.

In recent years, many users of mobile terminals wish to read electronic documents such as electronic books, electronic newspapers, electronic mail, and web pages on the screen. However, as a mobile terminal simply displays a specific electronic document, the user may be unable to utilize a supplementary function while reading the electronic document. In addition, because of screen size limitations, the user may have difficulty in reading and understanding an electronic document displayed on the screen. Hence, it is necessary to develop a mechanism that enables the user to easily read and utilize a displayed electronic document.

Therefore, a need exists for a display unit of a mobile terminal and a method of operating a mobile terminal that enable a user to easily read and utilize a displayed electronic document.

### SUMMARY OF THE INVENTION

An aspect of the present invention is to address at least the above-mentioned problems and to provide at least the advantages described below. Accordingly, an aspect of the present invention is to provide a method and apparatus that enable the user to manipulate a mobile terminal through coordinated operations of main and sub displays.

Another aspect of the present invention is also to provide a method and apparatus that enable a mobile terminal having at least two display units to display screen data in an organized manner through coordinated operations of the display units.

Another aspect of the present invention is further to provide a method and apparatus that enable a mobile terminal having at least two display units to display screen data through coordinated operations of the main and sub displays and to execute a function requested by a user input on the basis of screen data displayed on the sub display.

Another aspect of the present invention is further to provide a method and apparatus that enable a mobile terminal having at least two display units to operate the first display unit in the first mode and to display screen data in an organized manner through coordinated operations of the first and second display units after transitioning from the first mode to the second mode.

Another aspect of the present invention is further to provide a method and apparatus that enable a mobile terminal having at least two display units to assign the first display unit and the second display unit respectively to the first mode operation and the second mode operation and to execute a function requested by a user event when the second display unit is operated in the second mode.

Another aspect of the present invention is further to provide a method and apparatus that enable a mobile terminal having at least two display units to display an electronic document on the second display unit in an intuitive manner and to control a function according to a user input during document display on the second display unit.

In accordance with an aspect of the present invention, a method of operating a mobile terminal is provided. The method includes displaying screen data of an electronic document on a first display according to a user request, transforming, upon detection of a mode transition interaction, the screen data of the electronic document displayed on the first display, and displaying the transformed screen data of the electronic document on a second display.

In accordance with another aspect of the present invention, a display unit for a mobile terminal is provided. The display unit includes a first display displaying screen data related to a function executed in a first mode of the mobile terminal, and a second display displaying screen data related to a function executed in a second mode of the mobile terminal, and displaying, after transitioning from the first mode to the second mode, the screen data having been displayed on the first display in a continuous manner.

In accordance with another aspect of the present invention, a mobile terminal is provided. The mobile terminal includes a display means composed of at least two displays that are separately operable, and a control unit specifying one of the at least two displays as a first display supporting a first mode, specifying another one of the at least two displays as a second display supporting a second mode, and controlling the first display and second display to display screen data through coordinated operations thereof.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above mentioned aspect, features, and advantages of certain exemplary embodiments of the present invention will be more apparent from the following description taken in conjunction with the accompanying drawings, in which:

FIGS. 1 to 6 illustrate structures of mobile terminals according to exemplary embodiments of the present invention;

FIG. 7 is a block diagram of a mobile terminal according to an exemplary embodiment of the present invention;

FIG. 8 is a flowchart illustrating a procedure of operating display units when transitioning from a regular mode to a special mode according to an exemplary embodiment of the present invention;

FIG. 9 is a flow chart illustrating a procedure of operating display units when transitioning from a special mode to a regular mode according to an exemplary embodiment of the present invention;

FIGS. 10 and 11 are screen representations illustrating operations of a mobile terminal according to exemplary embodiments of the present invention; and

FIGS. 12 to 21 are screen representations illustrating operations of a second display unit in a mobile terminal according to exemplary embodiments of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present invention relates to a mobile terminal having at least two display units, and provides a method and apparatus that execute a desired function and control display of screen data through coordinated operations of the display units. In an exemplary embodiment, the mobile terminal having at least two display units can display screen data in an organized manner through coordinated operations of the display units. That is, a method and apparatus are provided to present electronic documents using two display units. In an exemplary embodiment, the mobile terminal may assign the first display unit and the second display unit respectively to a first mode operation and a second mode operation and control function execution in response to user events when the second display unit is operated in second mode.

To achieve this, the mobile terminal of the present invention may include a display means composed of at least two display units, and a control unit that may assign the first display unit and the second display unit respectively to the first mode and the second mode and control display of screen data using coordinated operations of the display units. In the following description, the first mode and the second mode may also be respectively referred to as the regular mode and the special mode. The first display unit assigned to the first mode (regular mode) may be referred to as the main display, and the second display unit assigned to the second mode (special mode) may be referred to as the sub display.

Next, a description is given of the configuration and operation of a mobile terminal according to exemplary embodiments of the present invention. However, the present invention is not limited to or by the following description, and various changes and modifications are possible on the basis of the following description.

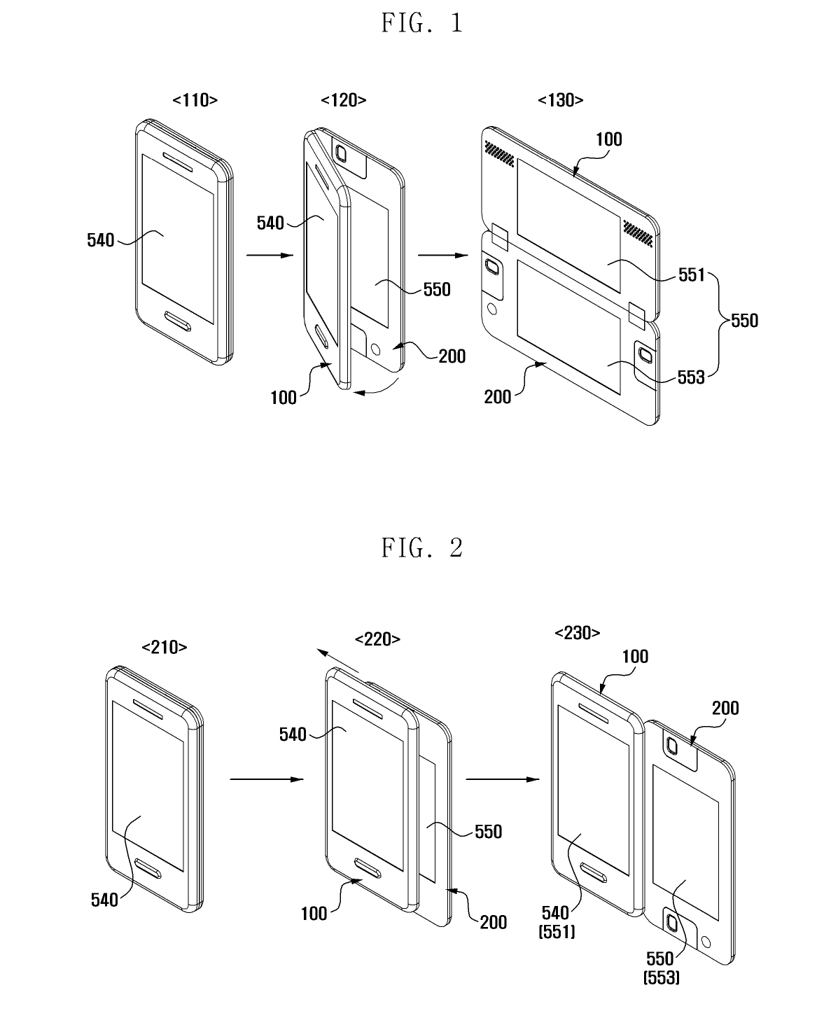

FIGS. 1 to 6 illustrate structures of mobile terminals according to exemplary embodiments of the present invention.

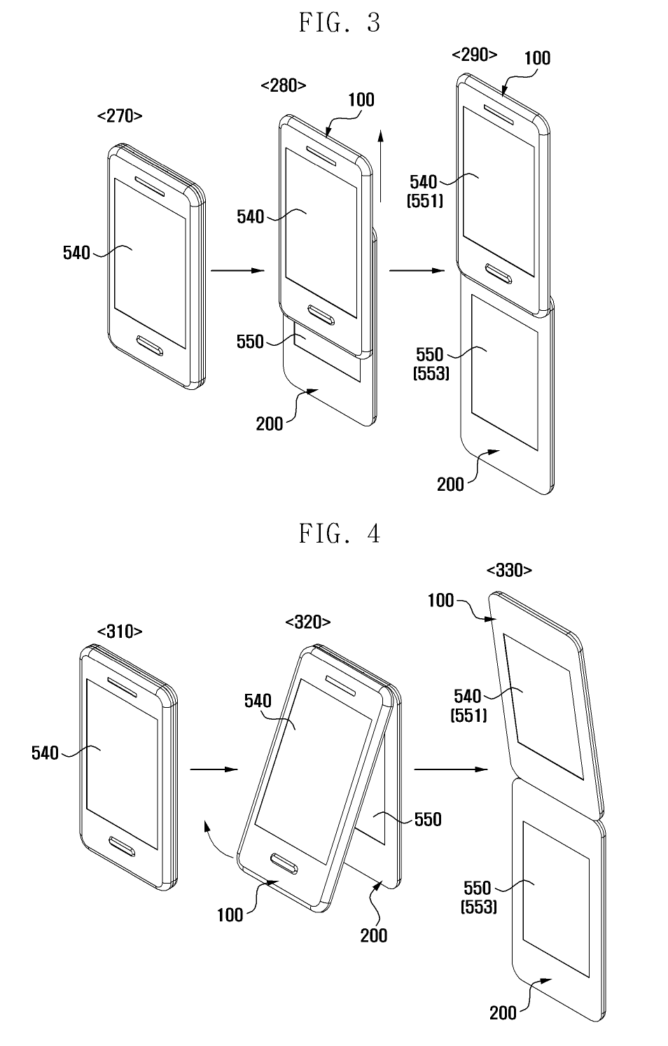

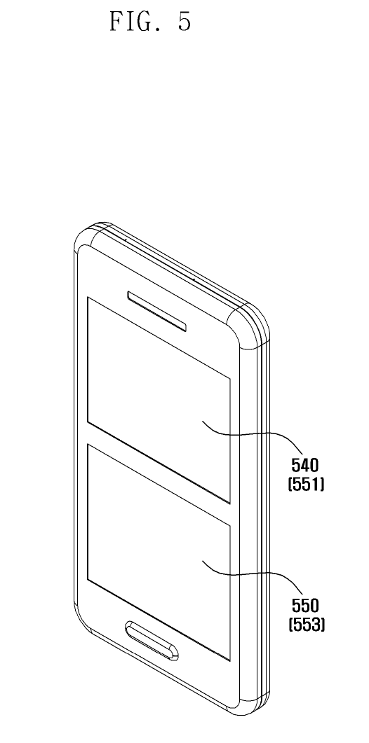

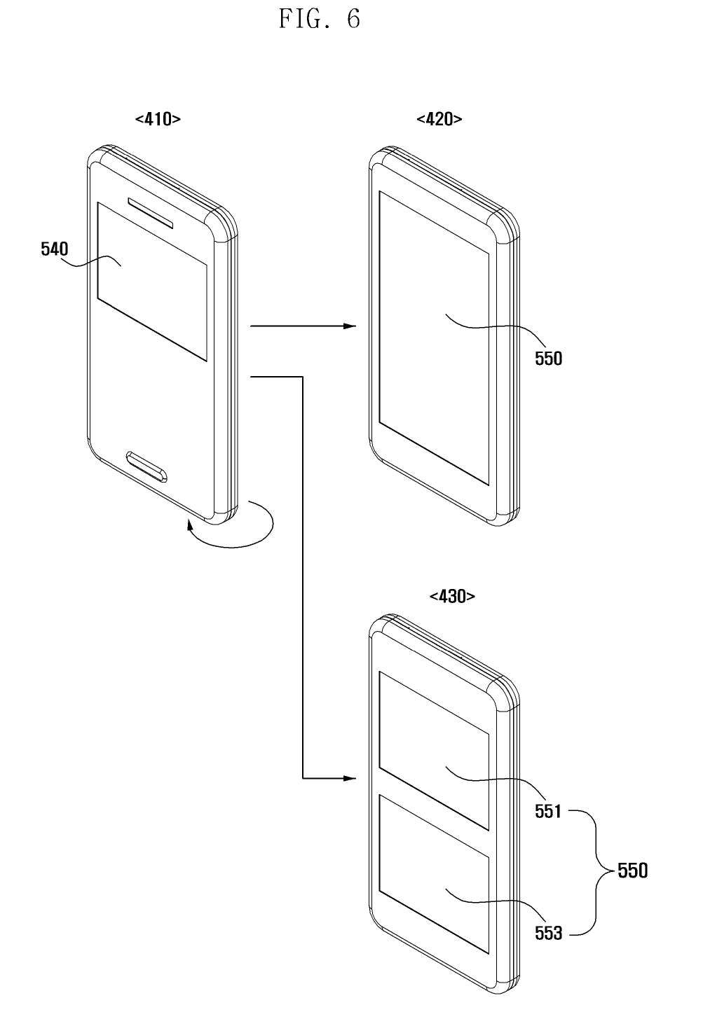

FIG. 1 depicts a mobile terminal of a landscape folder type; FIG. 2 depicts a mobile terminal of a landscape slide type; FIG. 3 depicts a mobile terminal of a portrait slide type; FIG. 4 depicts a mobile terminal of a portrait folder type; and FIGS. 5 and 6 depict mobile terminals of a portrait bar type. It is also possible to provide a mobile terminal of a landscape bar type.

Referring to FIGS. 1 to 6, the mobile terminal includes at least two display units 540 and 550. That is, the mobile terminal is equipped with two display units such as a main display 540 and a sub display 550, and each of the main display 540 and sub display 550 is used to display screen data related to a specific function on the basis of UI elements tailored to the function. For example, the main display 540 may display UI elements tailored to a first function (primary function) and screen data related to the first function, and the sub display 550 may display UI elements tailored to a second function (supplementary function) and screen data related to the second function. Here, the primary function and the supplementary function are introduced for the purpose of description, and may be determined according to functions and features supported by the mobile terminal.

Referring to FIGS. 1 to 6, the sub display 550 may be configured as a single entity or as multiple entities according to terminal types. For example, in the case of a folder type terminal as depicted in FIG. 1 or 4, the sub display 550 may be configured as two entities of an upper sub display 551 and a lower sub display 553. The sub display 550 of a folder type terminal may also be configured as a single entity, in which case the main display 540 may correspond to the upper sub display and the sub display 550 may correspond to the lower sub display.

In the case of a slide type terminal as depicted in FIG. 2 or 3, the sub display 550 may be configured as a single entity, in which case the main display 540 may correspond to the upper sub display and the sub display 550 may correspond to the lower sub display.

Referring to FIG. 5, a bar type mobile terminal may have two display units at the front. In this case, the sub display 550 may be configured as one or more entities at the front. As shown in FIG. 6, a bar type mobile terminal may have one display unit (or no display unit) at the front, and one display unit at the back. In this case, the sub display 550 may correspond to the display unit at the back. Alternatively, a bar type mobile terminal may have one display unit (or no display unit) at the front, and two or more display units at the back. In this case, the sub display 550 may correspond to two or more display units at the back. For example, the sub display 550 may be composed of an upper sub display 551 and a lower sub display 553 at the back.

In the case of a bar type terminal of FIG. 5 or 6, when the sub display 550 is configured as a single entity at the back of the mobile terminal, the main display 540 may correspond to the upper sub display and the sub display 550 may correspond to the lower sub display.

In the description, screen data display is performed on the basis of the main display 540 in the regular mode, and is performed on the basis of the sub display 550 in the special mode.

Referring to FIGS. 1 and 4, a folder type mobile terminal is in the regular mode as depicted in presentation 110 and presentation 310. The mobile terminal may operate only the main display 540 in the regular mode. The mobile terminal may display an idle screen and a function handling screen on the main display 540 in the regular mode. Particularly, in the regular mode, an update information indicator is provided in an update information zone (not shown in FIGS. 1 to 6) on the main display 540. When an input signal for determining update information is received in relation to the main display 540, the mobile terminal displays screen data corresponding to the update information on the main display 540. Here, the input signal may be generated by touching the update information zone, or by a function key of an input unit.

Next, as depicted in presentation 120 and presentation 320, the folder type mobile terminal is being opened by user manipulation. The mobile terminal is composed of a first body 100 and a second body 200. While the mobile terminal is being opened as depicted in presentation 110 and presentation 310, screen data on the main display 540 may be sustained. When the gap between the first body 100 and the second body 200 becomes greater than a given value by the opening action, the mobile terminal may detect a mode transition interaction corresponding to the opening action of the user.

Here, the mobile terminal may include a sensing means that detects a mode transition interaction related to a regular-to-special mode transition caused by opening the first body 100 and the second body 200 or related to a special-to-regular mode transition caused by closing the first body 100 and the second body 200. The mode transition interaction may be generated by a physical transition key, a soft transition key, voice recognition, or motion recognition.

Next, as depicted in presentation 130 and presentation 330, the folder type mobile terminal is completely opened by user manipulation. That is, presentation 130 and presentation 330 depict the mobile terminal in the special mode. In the completely opened state, the main display 540 may be deactivated, and screen data may be displayed on the sub display 550. In other words, the folder type mobile terminal in FIGS. 1 and 4 may operate only the sub display 550 in the special mode.

In the special mode, the folder type mobile terminal in FIGS. 1 and 4 may display a preset UI screen on the sub display 550, or may display screen data, which was being displayed on the main display 540 immediately before the body of the mobile terminal is opened, on the sub display 550. Here, the screen data displayed on the main display 540 may be resized according to the size of the sub display 550. For example, when a page of an electronic document is displayed on the main display 540, the page may be enlarged to fit the sub display 550 composed of the upper sub display 551 and the lower sub display 553. Display operation on the sub display 550 is described in detail later.

Referring to FIGS. 2 and 3, an exemplary slide type mobile terminal is in the regular mode as depicted in presentation 210 and presentation 270. Presentation 220 and presentation 280 depict that the mobile terminal is being opened by user manipulation. Here, the description given to presentation 110 and presentation 310 of FIGS. 1 and 4 is applicable to presentation 210 and presentation 270 of FIGS. 2 and 3, and the description given to presentation 120 and presentation 320 of FIGS. 1 and 4 is applicable to presentation 220 and presentation 280 of FIGS. 2 and 3. When the first body 100 and the second body 200 are slid apart to a predetermined degree by the opening action, the mobile terminal may detect a mode transition interaction corresponding to the opening action of the user.

Here, the mobile terminal may detect a mode transition interaction related to a regular-to-special mode transition caused by opening the first body 100 and the second body 200 or related to a special-to-regular mode transition caused by closing the first body 100 and the second body 200. The mode transition interaction may be generated by a physical transition key, a soft transition key, voice recognition or motion recognition.

Next, as depicted in presentation 230 and presentation 290, the mobile terminal is completely opened by user manipulation. That is, presentation 230 and presentation 290 depict the mobile terminal in the special mode. In the completely opened state, the main display 540 may stop independent operation, and may operate as the upper sub display 551 of the sub display 550. In other words, although the slide type mobile terminal in FIGS. 2 and 3 uses both the main display 540 and the sub display 550 in the special mode, the main display 540 is operated as the upper sub display 551 and the sub display 550 is operated as the lower sub display 553. Hence, in the special mode, screen data is displayed on the main display 540 acting as the upper sub display and the sub display 550 acting as the lower sub display.

In the special mode, the slide type mobile terminal in FIGS. 2 and 3 may display a preset UI screen on the sub display 550. When a page of an electronic document is displayed on the main display 540 immediately before the slide is opened, the mobile terminal may display the page on the main display 540 acting as the upper sub display and display the next page of the electronic document on the sub display 550 acting as the lower sub display after the slide is completely opened (i.e., in special mode). Alternatively, the mobile terminal may enlarge and resize the page of an electronic document that was displayed on the main display 540 to fit both the main display 540 (acting as the upper sub display) and the sub display 550 (acting as the lower sub display).

FIGS. 5 and 6 illustrate a bar type mobile terminal. The mobile terminal of FIG. 5 has a main display 540 and a sub display 550 at the front, and the mobile terminal of FIG. 6 has a main display 540 at the front and a sub display 550 at the back.

The bar type mobile terminal of FIG. 5 may display a UI screen on at least one of the main display 540 and the sub display 550. When a page of an electronic document is displayed on at least one of the main display 540 and the sub display 550 in the regular mode, after mode transitioning to the special mode, the mobile terminal may operate the main display 540 as the upper sub display and operate the sub display 550 as the lower sub display. A user interaction may trigger a mode transition between the regular mode and the special mode, and a mode transition interaction may be generated by a physical transition key, a soft transition key, voice recognition, or motion recognition.

In FIG. 6, the bar type mobile terminal is depicted in the regular mode in presentation 410. The mobile terminal may operate only the main display 540 in the regular mode. The mobile terminal may display an idle screen and a function handling screen on the main display 540 in the regular mode. Particularly, in the regular mode, an update information indicator is provided in an update information zone on the main display 540. When an input signal for determining update information is received in relation to the main display 540, the mobile terminal displays screen data corresponding to the update information on the main display 540. Here, the input signal may be generated by touching the update information zone, or by a function key of an input unit.

Next, as the user turns over the mobile terminal, the back of the mobile terminal is shown as depicted in presentation 420 or presentation 430. The mobile terminal in presentation 420 has one display unit at the back, and the mobile terminal in presentation 430 has at least two display units at the back. The bar type mobile terminal may detect a mode transition interaction corresponding to the turning over action of the user while operating the main display 540.

Here, the bar type mobile terminal in FIG. 6 may include a sensing means that detects a mode transition interaction for a regular-to-special mode transition, or a special-to-regular mode transition corresponding to the turning over action. The mode transition interaction may be generated by a physical transition key, a soft transition key, voice recognition, or motion recognition.

As depicted in presentation 420 or presentation 430, the bar type mobile terminal shows its back side, and hence is in the special mode. Upon transitioning to the special mode, the main display 540 may be deactivated and screen data may be displayed on the sub display 550. In other words, the bar type mobile terminal in FIG. 6 may operate only the sub display 550 in the special mode.

As depicted in presentation 420, the mobile terminal having one sub display in the special mode may display a preset UI screen on the single sub display 550, or may display screen data, which was being displayed on the main display 540 immediately before transitioning to the special mode, on the sub display 550. Here, the screen data displayed on the main display 540 may be resized or transformed according to the size of the sub display 550.

As depicted in presentation 430, the mobile terminal having two sub displays in the special mode may display a preset UI screen on the sub display 550 composed of the upper sub display 551 and the lower sub display 553, or may display screen data, which was being displayed on the main display 540 before, on the sub display 550 composed of the upper sub display 551 and the lower sub display 553. Here, the screen data displayed on the main display 540 may be resized or transformed according to the size of the sub display 550. For example, when a page of an electronic document was displayed before on the main display 540, the page may be resized to fit the sub display 550 composed of the upper sub display 551 and the lower sub display 553.

As described above, the mobile terminal of an exemplary embodiment of the present invention may display a UI screen on the basis of the sub display 550 in the special mode. For example, when a page of an electronic document is displayed on the main display 540 before transitioning the special mode, the page may be displayed on the sub display 550 (with or without use of the main display 540) in the special mode. As described in connection with FIGS. 1 to 6, the mobile terminal differentiates screen display in the special mode from screen display in the regular mode, and may provide a customized function for viewing electronic documents such as e-books, e-newspapers, web pages and e-mail. The mobile terminal of an exemplary embodiment of the present invention may include any type of terminal capable of operating multiple display units as shown in FIGS. 1 to 6.

Next, a description is given of the configuration of the mobile terminal of an exemplary embodiment of the present invention. However, the mobile terminal is not limited to or by the following description, and various changes and modifications are possible on the basis of the following description.

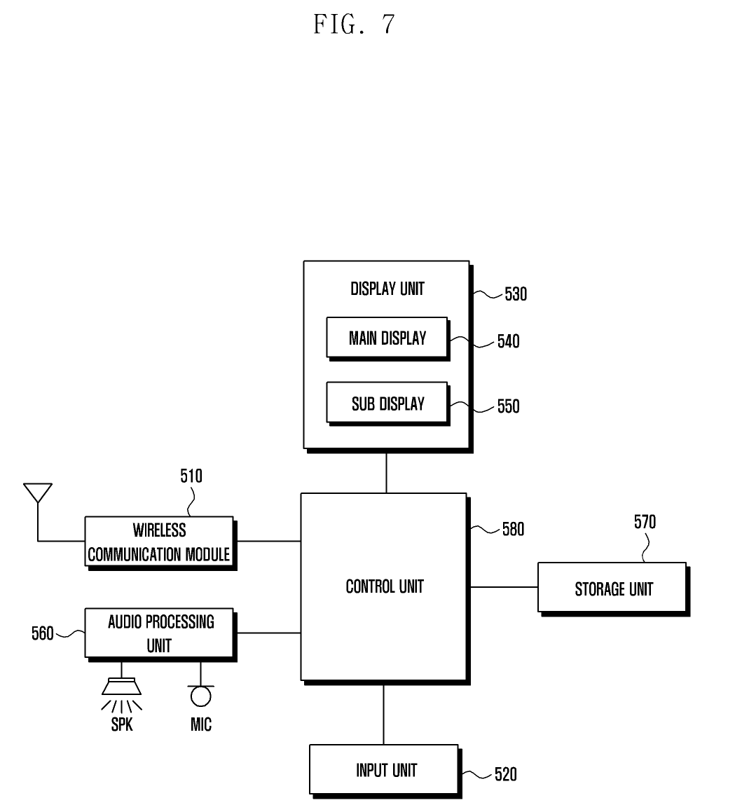

FIG. 7 is a block diagram of a mobile terminal according to an exemplary embodiment of the present invention.

Referring to FIG. 7, the mobile terminal may include a wireless communication module 510, an input unit 520, a display unit 530, an audio processing unit 560, a storage unit 570, and a control unit 580. The audio processing unit 560 may include a speaker SPK and a microphone MIC. The display unit 530 may include a main display 540 and a sub display 550. Next, each component of the mobile terminal 100 is described in greater detail.

The wireless communication module 510 performs communication operations for the mobile terminal. Under the control of the control unit 580, the wireless communication module 510 establishes a communication channel to a network (or a base station) in a preset manner, and sends and receives signals for radio communication related to voice calls and video calls and for data communication related to messaging services and Internet services. The wireless communication module 510 may include a transceiver (not shown) for upconverting the frequency of a signal to be transmitted and amplifying the signal, and for low-noise amplifying a received signal and downconverting the frequency of the received signal. Under the control of the control unit 580, the wireless communication module 510 transmits signals for incoming and outgoing calls through the established communication channel. Here, the communication channel may be a mobile communication channel based on Code Division Multiple Access (CDMA), Time Division Multiple Access (TDMA), Orthogonal Frequency Division Multiple Access (OFDMA), or an Internet Protocol (IP) channel based on a wired or wireless link. The wireless communication module 510 may include an Internet access interface (not shown) if necessary.

The input unit 520 transmits key signals from the user for inputting alphanumeric information and setting and controlling various functions of the mobile terminal to the control unit 580. The input unit 520 includes a plurality of alphanumeric and function keys for generating input signals. The function keys may include direction, side, and shortcut keys associated with corresponding functions. In particular, the input unit 520 includes a previous page key 863, a next page key 865 and a menu key 867 (keys not shown in FIG. 7) at the second body 200 or back of the mobile terminal, which are used when the sub display unit 550 is operated under the control of the control unit 580. The input unit 520 may include a mode change key to generate a mode transition interaction for causing a transition between the regular mode and the special mode. The input unit 520 may include one or more of a touch pad, a touch screen, and a keypad (3*4 or QWERTY layout), according to the design.

The display unit 530 displays a screen related to a function execution of the mobile terminal. In particular, the display unit 530 includes a main display 540, which is used as a basis for control operation of the control unit 580 in the regular mode, and a sub display 550, which is used as a basis for control operation of the control unit 580 in the special mode. The sub display 550 may be demarcated into an upper sub display 551 and a lower sub display 553. In the special mode, depending upon the type of the mobile terminal, the main display 540 may operate as the upper sub display 551, and the sub display 550 may operate as the lower sub display 553.

In the regular mode where ordinary user functions are handled, the main display 540 is used to display various screens related to states and operations of the mobile terminal, such as a boot screen, idle screen, menu screen, listing screen, playback screen and call handling screen. In the special mode where document handling functions are processed, the sub display 550 is used to display various screens related to states and operations of the mobile terminal, such as screens for an electronic book, electronic newspaper, web page, and electronic mail. The display unit 530 may be realized using Liquid Crystal Display (LCD) devices, Organic Light Emitting Diodes (OLED), or other display devices. When the display unit 530 has a touch screen capability, it may also act as an input/output means. Display operations based on the main display 540 and sub display 550 are described later in more detail with reference to the drawings.

The audio processing unit 560 may include a speaker SPK for reproducing an audio signal of the mobile terminal, and a microphone MIC for collecting an audio signal such as a voice signal of the user. The audio processing unit 560 is connected to the microphone MIC and speaker SPK. The audio processing unit 560 converts a voice signal from the microphone MIC into data and sends the data to the control unit 580, and outputs an audio signal from the control unit 580 through the speaker SPK. The audio processing unit 560 may reproduce various audio content generated by the mobile terminal (for example, an audio signal generated by media data playback and an audio signal alerting effects of function invocation) according to user selection. In an exemplary embodiment, speakers may be installed at the interior and exterior of the first body 100 to output audio signals in the regular mode and special mode. When the mobile terminal is a bar type terminal, it may have a speaker at one or both of the front and the back of the mobile terminal to output audio signals in the regular mode and special mode.

The storage unit 570 stores various data created or used by the mobile terminal. The data may include data generated in the course of function execution of the mobile terminal (for example, electronic documents, phonebooks, call logs, message data, music data, moving images, broadcast data and photographs), data created by the mobile terminal or received from external devices (for example, web servers, mobile terminals and personal computers), and applications related to functions and menus of the mobile terminal.

The storage unit 570 may store a software program controlling the coordinated operations of at least two displays. The storage unit 570 may store various information necessary for using the mobile terminal and for supporting the operation of the sub display 550 in the special mode. Such information may include update information, and is illustrated later.

The storage unit 570 may provide one or more buffers to temporarily store data generated in the course of operation of the mobile terminal. For example, the storage unit 570 may buffer screen data for continued display when the sub display 550 starts to operate after transitioning from the regular mode to the special mode. The storage unit 570 may include (not shown) internal storage media and external storage media such as a smart card. The storage unit 150 may include (not shown) a Read Only Memory (ROM), Random Access Memory (RAM), flash memory, and a combination thereof such as a multi-chip package.

The control unit 580 controls the overall operation of the mobile terminal, and controls signal exchange between the internal components thereof. The control unit 580 controls signal exchange between the wireless communication module 510, input unit 520, main display 540, sub display 550, audio processing unit 560, and storage unit 570.

The control unit 580 controls mode transition between the regular mode and special mode. When transitioning from the regular mode to the special mode, the control unit 580 controls an operation to transform the screen data being displayed on the main display 540 so as to fit the sub display 550 in terms of size and setting and to display the transformed screen data on the sub display 550. The control unit 580 controls operations of the mobile terminal using screen data being displayed on the sub display 550 in the course of operating the sub display 550.

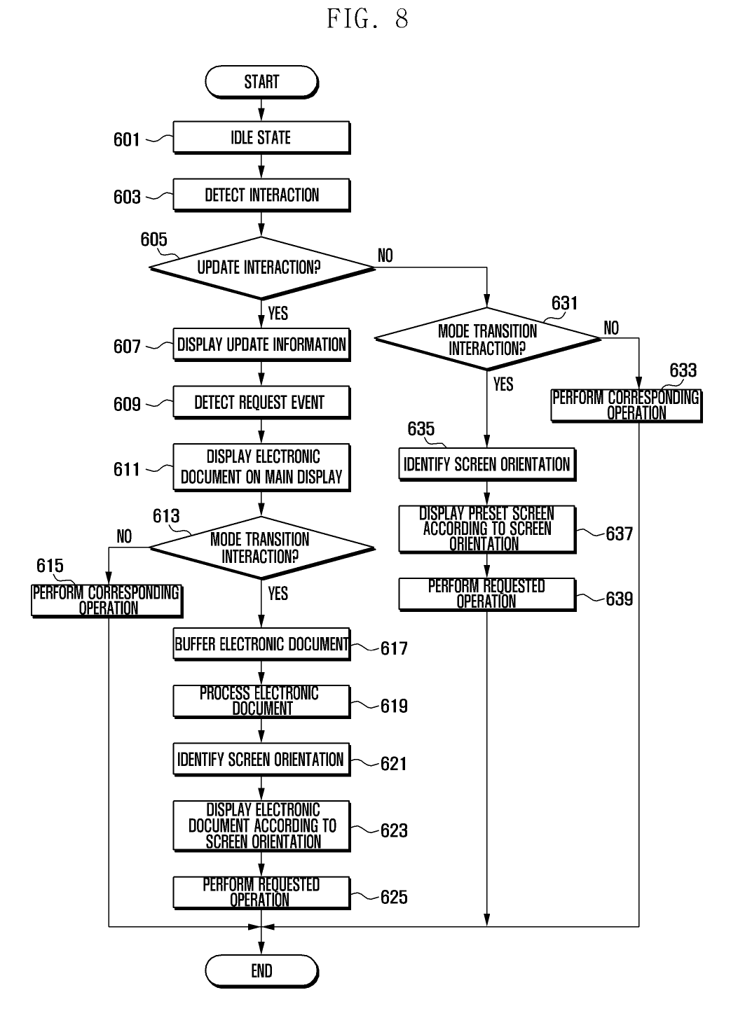

The control unit 580 may control operations of the mobile terminal related to an exemplary embodiment of the present invention. These control operations are described later in connection with FIGS. 8 to 21. The control operations of the control unit 580 may be implemented as software. The control unit 580 may be realized using a main controller and sub controller (not shown).

The configuration of the mobile terminal depicted in FIG. 7 is a simplified one for the purpose of description. However, the mobile terminal is not necessarily limited to or by such a configuration. For example, the mobile terminal may further include a baseband module (not shown) to receive a mobile communication service. One or both of the control unit 580 and the wireless communication module 510 may include the baseband module.

Although not shown in FIG. 7, according to design, the mobile terminal may further include various other features such as a GPS receiver to obtain location information, a short range communication module for short range communication, a camera module to capture still images or moving images of a target object, an interface module to perform data transmission and reception through a wired or wireless communication scheme, an Internet communication module for connecting to an Internet Protocol network for data and voice communication, and a digital broadcast reception module for receiving and reproducing digital broadcasts. It should be apparent to those skilled in the art that the mobile terminal may further include a unit comparable to (other than) the above-described units, and one unit may be removed or replaced by another unit.

The mobile terminal of an exemplary embodiment of the present invention may be any information and communication terminal capable of supporting the call handling function based on mobile communication or IP-based communication and supporting the special mode, such as a mobile communication terminal supporting a communication protocol for a communication system, a Portable Multimedia Player (PMP), a digital broadcast receiver, a Personal Digital Assistant (PDA), a music player such as an MP3 player, a portable game console, or a smart phone.

Hereinabove, a description is given of a mobile terminal having at least two displays that can provide a user interface through coordinated operations of the main display supporting the regular mode and the sub display supporting the special mode. Next, a description is given of a method that provides UI features through coordinated operations of the main display and the sub display. However, the method is not limited to or by the following description, and various changes and modifications are possible on the basis of the following description.

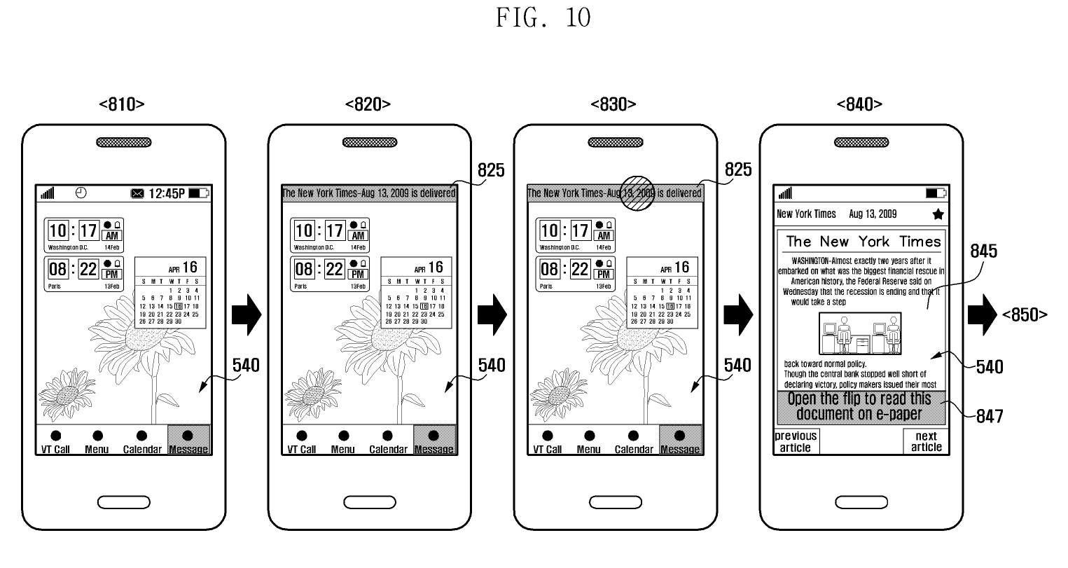

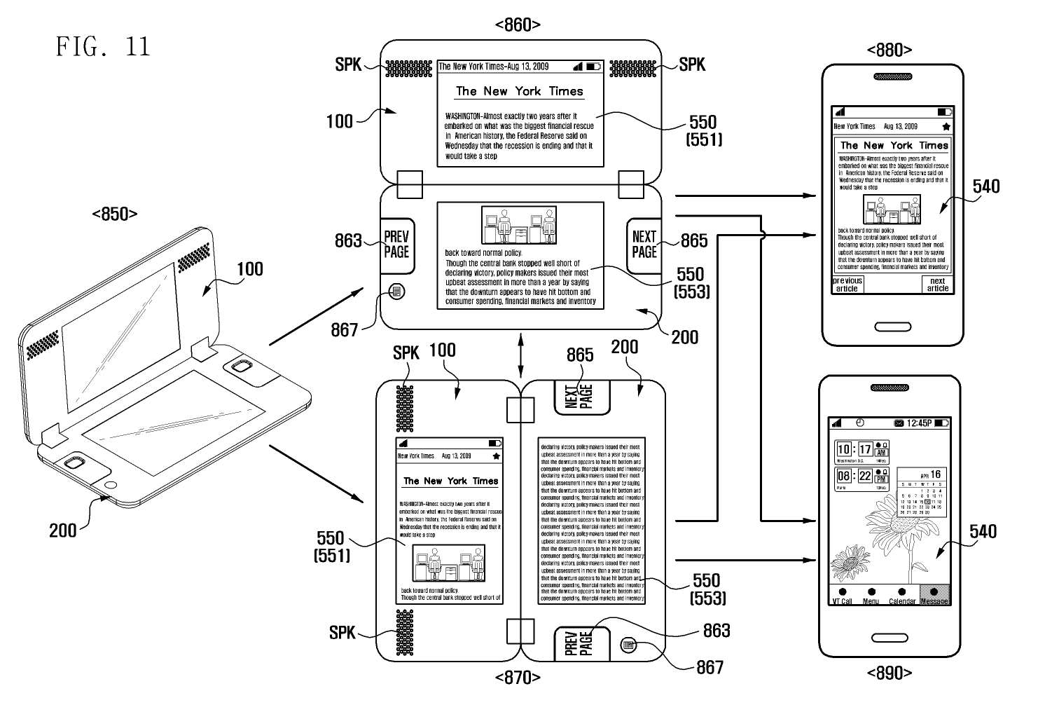

FIG. 8 is a flowchart illustrating a procedure of operating display units when transitioning from a regular mode to a special mode according to another exemplary embodiment of the present invention. FIGS. 10 and 11 are screen representations illustrating operations of the mobile terminal.

Referring to FIG. 8, the control unit 580 of the mobile terminal is exemplarily in the idle state of the regular mode as depicted in presentation 110 (FIG. 1), presentation 210 (FIG. 2), presentation 270 (FIG. 3), presentation 310 (FIG. 4), or presentation 410 (FIG. 5 or 6) in step 601. Here, the control unit 580 may control the main display 540 to display the idle screen and screen data related to icons and widgets, as shown in presentation 810 of FIG. 10. Although the mobile terminal is assumed in this example to be in the idle state at the beginning, it does not necessarily start the method with the idle state.

The control unit 580 detects an interaction in the idle state in step 603. Here, an interaction may be an update interaction or a user interaction related to user manipulation. An update interaction may indicate arrival of update information of one of preset electronic documents from a related service server.

The control unit 580 determines whether the detected interaction is an update interaction related to electronic document update in step 605. When the detected interaction is not an update interaction, the control unit 580 may determine whether the detected interaction is a mode transition interaction related to screen display mode. Here, the mode transition interaction may be a user interaction requesting transition from the regular mode to the special mode. Depending upon the type of the mobile terminal, the mode transition interaction may be a body opening interaction generated by opening the first body 100 and the second body 200, a key interaction generated by a physical key or a soft key, a voice interaction generated by voice recognition, or a motion interaction generated by motion recognition based on terminal state changes.

Hence, the control unit 580 may detect various types of mode transition interactions. FIGS. 8, 10 and 11 are related to handling of a body opening interaction in a folder type terminal as shown in FIG. 1.

When the detected interaction is an update interaction, the control unit 580 displays update information, received from an external service server, in the update information zone in step 607. Display of update information is illustrated in presentation 820 of FIG. 10. As depicted in presentation 820, the control unit 580 may display newly received update information in an update information zone 825 of the main display 540.

After display of the update information, the control unit 580 detects a request event from the user in step 609. Here, a request event refers to a user input for outputting an electronic document related to the update information, and may be a touch event occurring directly on the update information zone or a key event generated by a function key associated with electronic document output. In the exemplary description, the request event is assumed to be a touch event on the touch screen, as illustrated in presentation 830 of FIG. 10.

Upon detection of the request event, the control unit 580 displays an electronic document 845 related to the update information on the main display 540 in step 611. Here, the control unit 580 may download the electronic document and buffer or store the same immediately after the update information is received, and display the buffered or stored electronic document on the main display 540 in response to the request event. Alternatively, the control unit 580 may connect to a service server providing the electronic document on the basis of a link contained in the update information, and receive the electronic document related to the update information from the service server and display the electronic document on the main display 540. Display of an electronic document caused by a request event is illustrated in presentation 840 of FIG. 10.

As depicted in presentation 840 of FIG. 10, the control unit 580 provides the electronic document related to the update information through the main display 540. During document display on the main display 540, the control unit 580 may output a popup window 847 containing a guide message such as, “open the flip to read this document on e-paper.” That is, the mobile terminal may encourage the user to conveniently view the electronic document in the special mode.

The operations describe above may be related to electronic documents having related update information such as electronic newspapers and electronic mail. As to electronic documents without associated update information such as web pages and electronic books, operations related to update information and request events may be skipped.

Thereafter, the control unit 580 determines whether a mode transition interaction is generated in step 613. When a mode transition interaction is not generated, the control unit 580 may perform a requested operation in step 615. For example, the control unit 580 may place a call and display a call handling screen on the main display 540 in response to a call request, or the control unit 580 may execute a function and display a related screen on the main display 540 in response to selection of a menu item or an icon by the user.

When a mode transition interaction is generated, the control unit 580 buffers the electronic document in step 617. Here, the electronic document may be one of an electronic book, electronic newspaper, electronic mail, and web page, and is buffered so as to be displayed on the sub display 550 after transitioning from the regular mode to the special mode. A mode transition interaction may be generated when the gap between the first body 100 and the second body 200 becomes greater than a given value by an opening action, as shown in presentation 850 of FIG. 11. The mode transition interaction may also be generated by a physical transition key, a soft transition key, voice recognition, or motion recognition.

The control unit 580 processes the buffered electronic document for display using the sub display 550 in step 619. For example, the control unit 580 may optimize the character size or font of an HTML (HyperText Markup Language) or XML (eXtensible Markup Language) based electronic document for the sub display 550.

The control unit 580 identifies the screen orientation of the sub display 550 in step 621. The sub display 550 may operate in portrait or landscape orientation. To identify the screen orientation, the mobile terminal may include a geomagnetic sensor or an acceleration sensor. The control unit 580 may identify the screen orientation on the basis of a sensing signal from the sensor.

The control unit 580 displays the processed electronic document on the sub display 550, according to the identified screen orientation in step 623. Presentation 860 of FIG. 11 illustrates document display in landscape orientation, and presentation 870 of FIG. 11 illustrates document display in portrait orientation.

As depicted in presentation 860 of FIG. 11 (landscape orientation), the control unit 580 may display the electronic document in a magnified format on the sub display 550 composed of an upper sub display 551 and lower sub display 553. Here, a single page of the electronic document having been displayed on the main display 540 is enlarged and displayed on the sub display 550 composed of the upper sub display 551 and lower sub display 553.

As depicted in presentation 860 of FIG. 11 (portrait orientation), the control unit 580 may display the electronic document on the sub display 550 composed of an upper sub display 551 and lower sub display 553. Here, a page of the electronic document having been displayed on the main display 540 is displayed on the upper sub display 551, and the next page thereof is displayed on the lower sub display 553.

As depicted in presentation 860 and presentation 870 of FIG. 11, the mobile terminal may include one or more speakers SPK for audio signal output and physical keys 863, 865 and 867 for page navigation or menu activation at the first body 100 and the second body 200. For example, the first body 100 providing the upper sub display 551 may include a speaker SPK, and the second body 200 providing the lower sub display 553 may include a previous page key 863, next page key 865, and menu key 867. Here, the first body 100 and second body 200 of the mobile terminal are not necessarily limited to the configuration depicted in presentation 860 and presentation 870. According to the design, for example, the mobile terminal may be a full touch-screen terminal having wider touch screens covering the first body and second body.

Referring back to FIG. 8, the control unit 580 may perform an operation requested by the user after document display on the sub display 550 in step 625. For example, the control unit 580 may control page transitions according to user manipulation of the previous page key 863 and next page key 865, or control activation of a base menu, option menu, and sub option menu, and carry out an operation associated with a selected menu item according to manipulation of the menu key 867. Operations related to document display are described later with reference to the drawings.

When the detected interaction is not an update interaction at step 605, the control unit 580 determines whether the detected interaction is a mode transition interaction in step 631.

When the detected interaction is not a mode transition interaction, the control unit 580 may perform a requested operation in step 633. For example, the control unit 580 may place a call and display a call handling screen on the main display 540 in response to a call request, or the control unit 580 may execute a function and display a related screen on the main display 540, in response to selection of a menu item or an icon by the user.

When the detected interaction is a mode transition interaction, the control unit 580 identifies the screen orientation of the sub display 550 in step 635. The sub display 550 may operate in portrait or landscape orientation. The control unit 580 displays a preset screen on the sub display 550 according to the identified screen orientation in step 637. For example, the control unit 580 may display an initial menu screen according to activation of the sub display 550, an idle screen tailored to the sub display 550, or the most recently viewed electronic document on the sub display 550.

The control unit 580 may perform an operation requested by the user after display on the sub display 550 in step 639. For example, the control unit 580 may control page transitions according to user manipulation of the previous page key 863 and next page key 865, or control activation of a menu and carry out an operation associated with a selected menu item according to manipulation of the menu key 867. Such operations are described later with reference to the drawings.

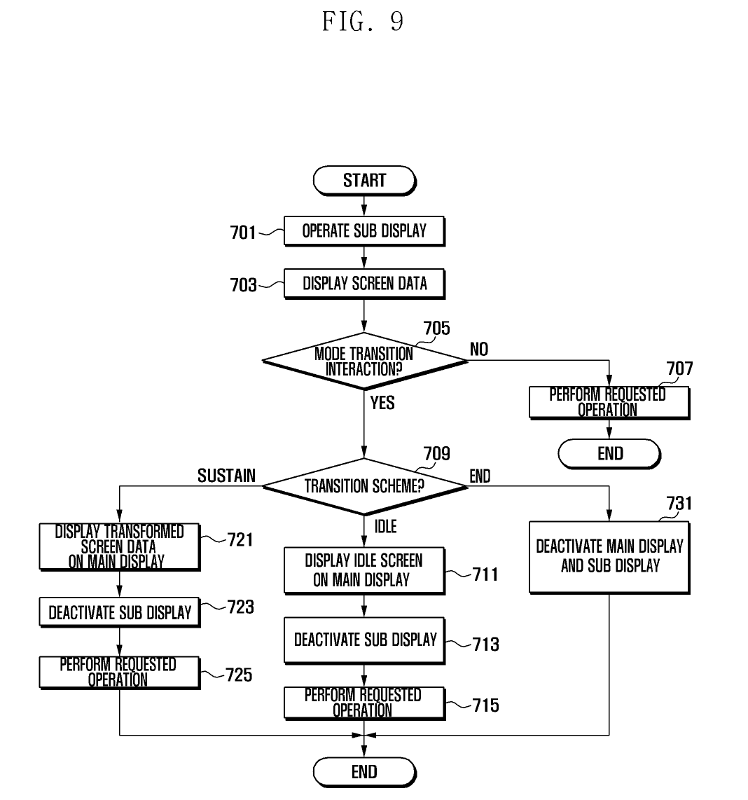

Hereinabove, a description is given of operations related to transitioning from the regular mode (body closed state) to the special mode (body open state) in connection with FIGS. 8, 10, and 11. Next, a description is given of operations related to transitioning from the special mode (body open state) to the regular mode (body closed state) in connection with FIGS. 9 and 11.

FIG. 9 is a flowchart illustrating a procedure of operating display units when transitioning from a special mode to a regular mode according to another exemplary embodiment of the present invention.

Referring to FIG. 9, the control unit 580 of the mobile terminal operates the sub display 550 in the special mode in step 701, and displays screen data on the sub display 550 in step 703. Operations in the special mode have been described before in connection with FIGS. 8, 10, and 11.

The control unit 580 determines whether a mode transition interaction is generated during display on the sub display 550 in step 705. Here, the mode transition interaction may be a user interaction requesting transition from the special mode to the regular mode. Depending upon the type of the mobile terminal, the mode transition interaction may be a body closing interaction generated by closing the first body 100 and the second body 200, a key interaction generated by a physical key or a soft key, a voice interaction generated by voice recognition, or a motion interaction generated by motion recognition based on terminal state changes.

Hence, the control unit 580 may detect various types of mode transition interactions. FIGS. 9 and 11 are related to handling of a body closing interaction in a folder type terminal as shown in FIG. 1. At step 705, the mode transition interaction corresponds to a body closing interaction generated by closing the first body 100 and the second body 200 (i.e., the reverse of a body opening interaction).

When a mode transition interaction is not generated, the control unit 580 may perform a requested operation in step 707. For example, the control unit 580 may continue to process requested operations during screen display on the sub display 550, or may end the special mode according to a body closing action of the user and perform a preset operation in the regular mode.

When a mode transition interaction is generated, the control unit 580 determines the transition scheme in step 709. The transition scheme specifies how to handle the ongoing operation (such as screen display) at the time when a mode transition interaction is generated during document display on the sub display 550, and may be set by the user or by default. The transition scheme may exemplarily be set to one of “sustain,” “idle,” and “end.”

When the transition scheme is set to “idle” (for idle state), the control unit 580 operates the main display 540 and displays the idle screen on the main display 540 in step 711. In other words, the control unit 580 enters the idle state, as depicted in presentation 890 of FIG. 11. The control unit 580 deactivates the sub display 550 after transitioning to the regular mode in step 713. For example, the control unit 580 may turn off the sub display 550, and initialize the UI screen and document display on the sub display 550.

The control unit 580 may perform an operation requested by the user in step 715. For example, as depicted in presentation 890 of FIG. 11, the control unit 580 may perform an operation requested by the user using the idle screen. The control unit 580 may turn off the main display 540 when no user interaction is generated for longer than a preset time.

When the transition scheme is set to “sustain,” the control unit 580 operates the main display 540 and displays the electronic document having been displayed on the sub display 550 on the main display 540 in step 721. Here, the electronic document may be resized so as to fit the main display 540, as depicted by a transition from presentation 860 or 870 to presentation 880 in FIG. 11.

As depicted by a transition from presentation 870 to presentation 880 in FIG. 11, when the sub display 550 composed of the upper sub display 551 and lower sub display 553 was operated in portrait orientation, the control unit 580 may display the page of the electronic document that was displayed on the upper sub display 551 on the main display 540.

The control unit 580 deactivates the sub display 550 after transitioning to the regular mode in step 723. For example, the control unit 580 may turn off the sub display 550, and initialize the UI screen and document display on the sub display 550.

The control unit 580 may perform an operation requested by the user in step 725. For example, as depicted in presentation 880 of FIG. 11, the control unit 580 may perform an operation requested by the user while the electronic document is being displayed. The control unit 580 may end document display and enter the idle state.

When the transition scheme is set to “end”, the control unit 580 deactivates the main display 540 and the sub display 550 after transitioning to the regular mode in step 731. For example, the control unit 580 may keep the main display 540 in the off state, and deactivate the sub display 550 and initialize the UI screen and document display.

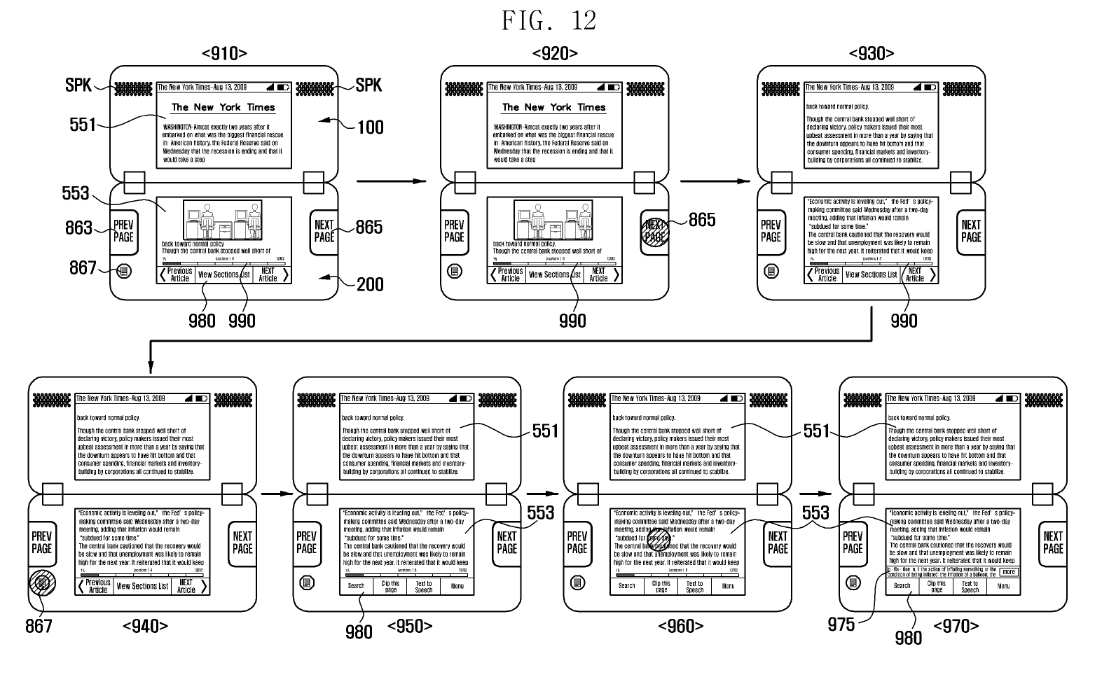

FIG. 12 depicts screen representations illustrating operations of a sub display in a mobile terminal according to an exemplary embodiment of the present invention.

Referring to FIG. 12, as depicted in presentation 910, the control unit 580 of the mobile terminal may display screen data on the sub display 550 according to a user request. Here, the screen data may correspond to an electronic document that was displayed on the main display 540 according to selection of related update information and was resized to fit the sub display 550, or may correspond to screen data produced by executing a function (such as viewing a stored electronic book) after opening the first body 100 and second body 200.

As depicted in presentation 910, the first body 100 may provide the upper sub display 551 of the sub display 550 and a speaker SPK; and the second body 200 may provide the lower sub display 553 of the sub display 550, the previous page key 863, the next page key 865, and the menu key 867. The lower sub display 553 may include a menu zone 980 in which a base menu related to the screen data and an option menu activated by the menu key 867 are output in the form of a soft key.

The menu zone 980 may be displayed or not displayed according to the source of the current screen data on the sub display 550. Display of the menu zone 980 may also be toggled on and off according to a user input. The lower sub display 553 may further include a related information zone 990 in which information related to the current screen data is displayed. When an electronic document is being displayed on the sub display 550, the total number of pages of the electronic document, the page number of the current page and the ratio of the current page number to the total number of pages (i.e., a progress indicator) may be output on the related information zone 990.

Thereafter, the user may generate an input signal for turning to the previous or next page using the previous page key 863 and the next page key 865. For example, the user may enter the next page key 865 as depicted in presentation 920 to generate an input signal for viewing the next page. Then, the control unit 580 regards the input signal generated by the next page key 865 as a request event for turning to the next page, and displays the next page of the electronic document as depicted in presentation 930. At this time, the contents of the related information zone 990 change as a result of page turning as depicted in presentation 930. That is, the control unit 580 may update the current page number and progress indicator in the related information zone 990 in response to turning to the next page.

The user may generate an input signal for activating the option menu to invoke a particular function through the menu key 867 while a page is displayed as depicted in presentation 920 or 930. For example, the user may enter the menu key 867 as depicted in presentation 940 to activate the option menu for invoking a particular function in a state where screen data is displayed as depicted in presentation 930. Then, the control unit 580 regards the input signal generated by the menu key 867 as a request event for activating the option menu, and replaces the base menu in the menu zone 980 with the option menu as depicted in presentation 950.

In addition, the control unit 580 may control the touch functionality of the upper sub display 551 and lower sub display 553 of the sub display 550. For example, in the process of displaying the initial screen and transferred screen data after opening the body as depicted in presentations 910 to 940, the control unit 580 may deactivate the input functionality (touch functionality) of the sub display 550 and activate only the display functionality thereof.

Here, the control unit 580 may selectively activate and deactivate the functionality of the menu zone 980. For example, in the case of an electronic book taking a long time to read, the control unit 580 may block display of the menu zone 980 and disable the input functionality thereof by default and permit the menu zone 980 to be output and activate the input functionality thereof only by user request. In the case of an electronic newspaper taking a short time to read and needing frequent page turning, the control unit 580 may permit the menu zone 980 to be output and activate the input functionality thereof. When an option menu is activated according to an input signal generated by the menu key 867 in a state in which the input functionality of the sub display 550 is deactivated, the control unit 580 may activate the input functionality of the sub display 550. Hence, the power consumption of the sub-display 550 can be reduced.

The user may make a gesture to execute a desired function while the option menu is activated as depicted in presentation 950. For example, the user may make a gesture through the sub display 550 to search a dictionary for a specific word selected from the screen data displayed on the sub display 550 as depicted in presentation 960.

As depicted in presentation 960, the user may generate a request event by tapping a specific word (for example, ‘inflation’) on the lower sub display 553. Then, the control unit 580 may extract the tapped word and search a given dictionary for the word.

When the dictionary search is completed, the control unit 580 may output the search result through a popup window 975 as depicted in presentation 970. The popup window 975 may be output above the menu zone 980 on the lower sub display 553 as shown, may be output at any location of the lower sub display 553 in consideration of the tap event, or may be output at any location of the upper sub display 551 for viewing convenience.

Thereafter, the control unit 580 may execute a clipping function in response to a user input through the popup window 975. The control unit 580 may remove the popup window 975 from the lower sub display 553 upon expiration of a preset time after output or by user request, as depicted in presentation 960.

As described above in connection with FIG. 12, the user may easily read an electronic document using the sub display 550 providing a wider screen, and automatically consult a dictionary to find the meaning of a specific word while reading the electronic document.

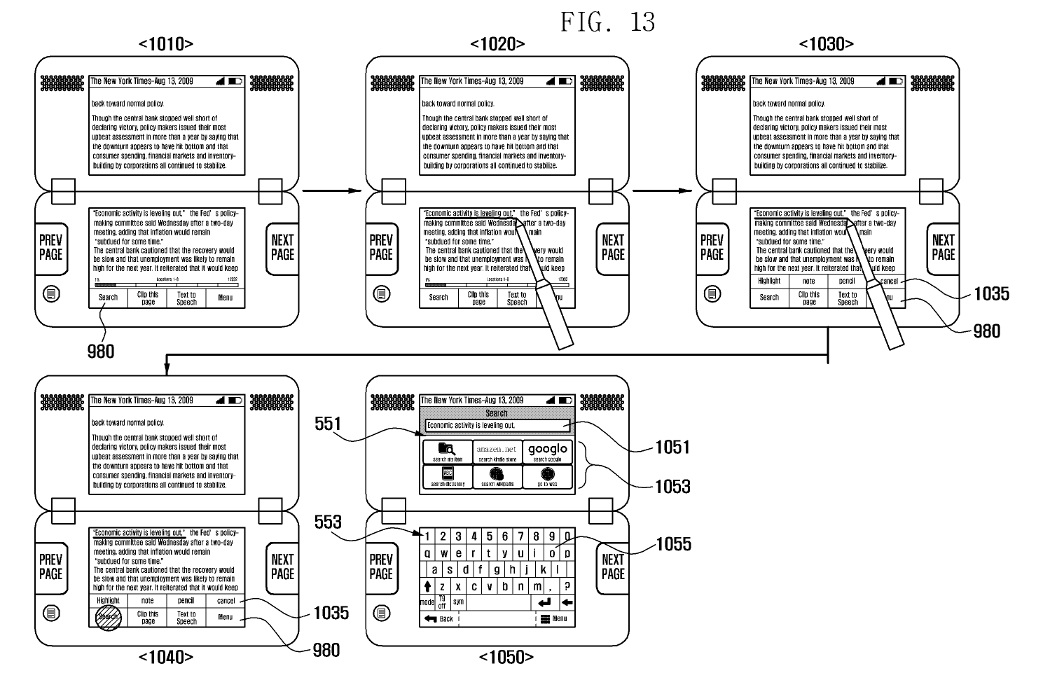

FIG. 13 depicts screen representations illustrating operations of a sub display in a mobile terminal according to an exemplary embodiment of the present invention.

Referring to FIG. 13, as depicted in presentation 1010, the control unit 580 of the mobile terminal may display screen data on the sub display 550 according to a user request. Here, the screen data may correspond to an electronic document that was displayed on the main display 540 according to selection of related update information and was resized to fit the sub display 550, or may correspond to screen data produced by executing a function (such as viewing a stored electronic book) after opening the first body 100 and second body 200.

For example, the screen data may be the same as that in presentation 950 or 970 of FIG. 12. It is assumed in this example that presentation 1010 of FIG. 13 corresponds to presentation 950 of FIG. 12. Hence, in presentation 1010 of FIG. 13, an option menu is activated in the menu zone 980 and the input functionality of the sub display 550 is activated accordingly.

The user may make a gesture to execute a desired function while the option menu is activated as depicted in presentation 1010. For example, the user may make a gesture of underlining a word, sentence or paragraph in the screen data on the sub display 550 as depicted in presentation 1020.

As depicted in presentation 1020, the user may generate a request event to underline a sentence, such as, “Economic activity is leveling out,” on the lower sub display 553, by dragging. Then, the control unit 580 draws a line under the sentence in real time by tracking the dragging action.

When the dragging action ends, the control unit 580 may change the line under the sentence to a straight line, and output a sub option menu 1035 above the menu zone 980 on the lower sub display 553, as depicted in presentation 1030.

The user may manipulate the underlined words in various ways using the option menu in the menu zone 980 and the sub option menu 1035. For example, the user may select an item “handwriting” or “pencil” of the sub option menu 1035 to change the straight line under the sentence to a line drawn by tracking the dragging action. The user may select an item “cancel” of the sub option menu 1035 to return to presentation 1010 without an underline. The user may select an item “highlight” of the sub option menu 1035 to highlight the underlined sentence.

The user may control execution of various functions using items of the option menu in the menu zone 980. In the following description of FIG. 13, execution of a search function is illustrated.

As depicted in presentation 1040, the user may select the “search” item of the option menu in the menu zone 980. The control unit 580 provides UI elements tailored to the search function on the sub display 550 as depicted in presentation 1050. For example, the control unit 580 may output a preset search screen on the upper sub display 551, and output a virtual keypad 1055 for entering keywords on the lower sub display 553. The search screen on the upper sub display 551 may include a search word field 1051 and search option items 1053 for performing various types of searches.

When the search function is activated by selecting the “search” item, the control unit 580 may automatically enter the underlined words (as depicted in presentations 1020 to 1040) in the search word field 1051. That is, the control unit 580 may extract and buffer the underlined words, and use the underlined words when the search function is activated.

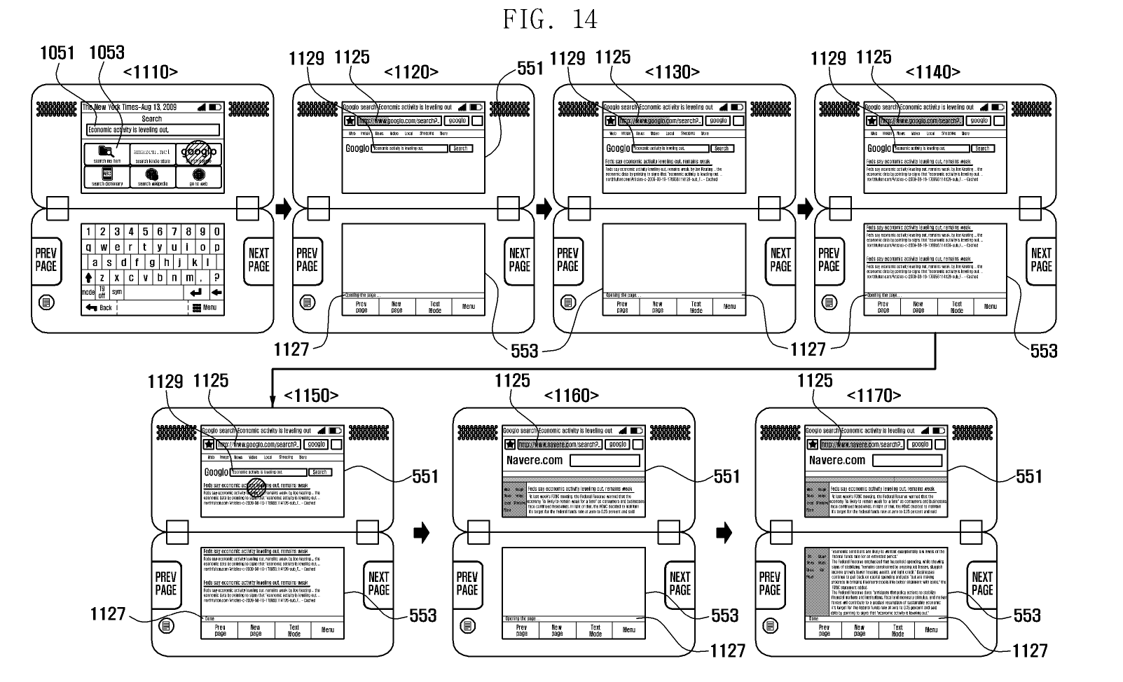

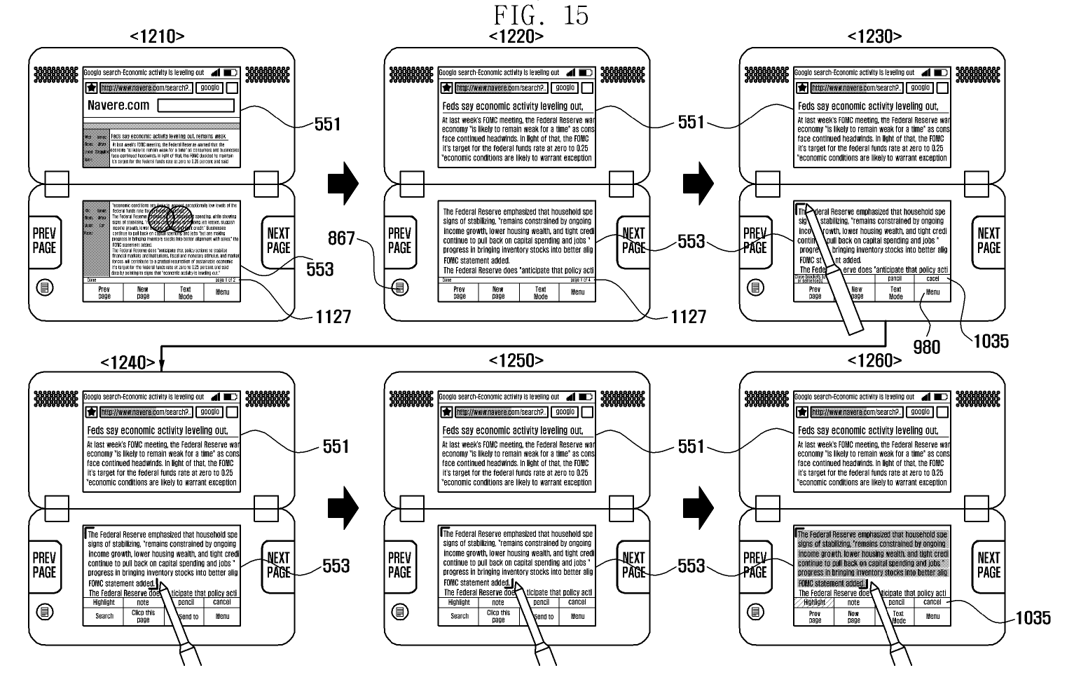

As depicted in presentation 1050, the control unit 580 may perform a search according to a search option selected by the user. For example, the control unit 580 may search one of the storage unit 570 of the mobile terminal, a given website, and a dictionary for given keywords according to a user selection. The search option items 1053 on the search screen are associated with different search options, and the user may conduct a search using specified search options. Such a search procedure is illustrated in FIG. 14.

As described above, the user may select characters (words, sentences or paragraphs) in the screen data on the sub display 550 and generate an input signal by making a gesture. The control unit 580 may receive the input signal and determine the meaning of the gesture with respect to the selected characters. For example, the gesture may indicate one of highlighting the selected characters, adding a note to the selected characters, performing a search using the selected characters, and adding the selected characters to an electronic mail as an attachment or content.

The control unit 580 may control execution of a function corresponding to the gesture. For example, the control unit 580 may control a process of highlighting the selected characters, adding a note to the selected characters, performing a search using the selected characters, or adding the selected characters to an electronic mail as an attachment or content.

FIG. 14 depicts screen representations illustrating operations of a sub display in a mobile terminal according to an exemplary embodiment of the present invention.

Referring to FIG. 14, as depicted in presentation 1110, the user may generate a request event to access a desired site by tapping one of the search option items 1053. The control unit 580 of the mobile terminal may control an operation to connect to a search server linked with the tapped search option item 1053 and to display a web page received from the search server. This process is illustrated in presentations 1120 to 1150.

Specifically, the control unit 580 identifies a search server linked with the tapped search option item 1053 (for example, a Google web server), connects to the identified search server, and sends search words entered in the search word field 1051 (i.e., underlined sentence) to the search server. The search server extracts information corresponding to the search words and sends the extracted information in the form of a web page to the mobile terminal. Here, the web page may exemplarily be written in HTML or XML.

The control unit 580 downloads the web page from the search server and displays the web page on the sub display 550. For example, as depicted in presentations 1120 to 1150, the control unit 580 outputs a download progress indicator in an address input box 1125 and displays screen data on the sub display 550 from the upper sub display 551 to the lower sub display 553. The download progress indicator may be in the form of a progress bar in the address input box 1125. For example, the control unit 580 may gradually fill the address input box 1125 with a given color according to the download progress as depicted in presentations 1120 to 1140, and remove the download progress indicator when the current web page is completely downloaded as depicted in presentation 1150.

The download progress information may also be output in the related information zone 1127. For example, the control unit 580 may output a descriptive phrase “opening the page . . . ” in the related information zone 1127 while download is in progress after connecting to the search server as depicted in presentations 1120 to 1140, and may output a descriptive word “done” in the related information zone 1127 when the current web page is completely downloaded as depicted in presentation 1150.

As depicted in presentation 1150, when the web page containing search results found using the provided key words is completely downloaded, the control unit 580 displays the web page on the sub display 550 composed of the upper sub display 551 and lower sub display 553. Here, the provided search words may be automatically output in a search word field 1129 of the web page. As depicted in presentation 1150, the user may generate a request event to select a desired search link in the screen data by tapping the search link.

As depicted in presentations 1160 and 1170, the control unit 580 connects to a service server indicated by the tapped search link and displays a web page received from the service server on the sub display 550. Here, information related to web page downloading and display may be provided in a manner similar to that described above in connection with presentations 1120 to 1140.

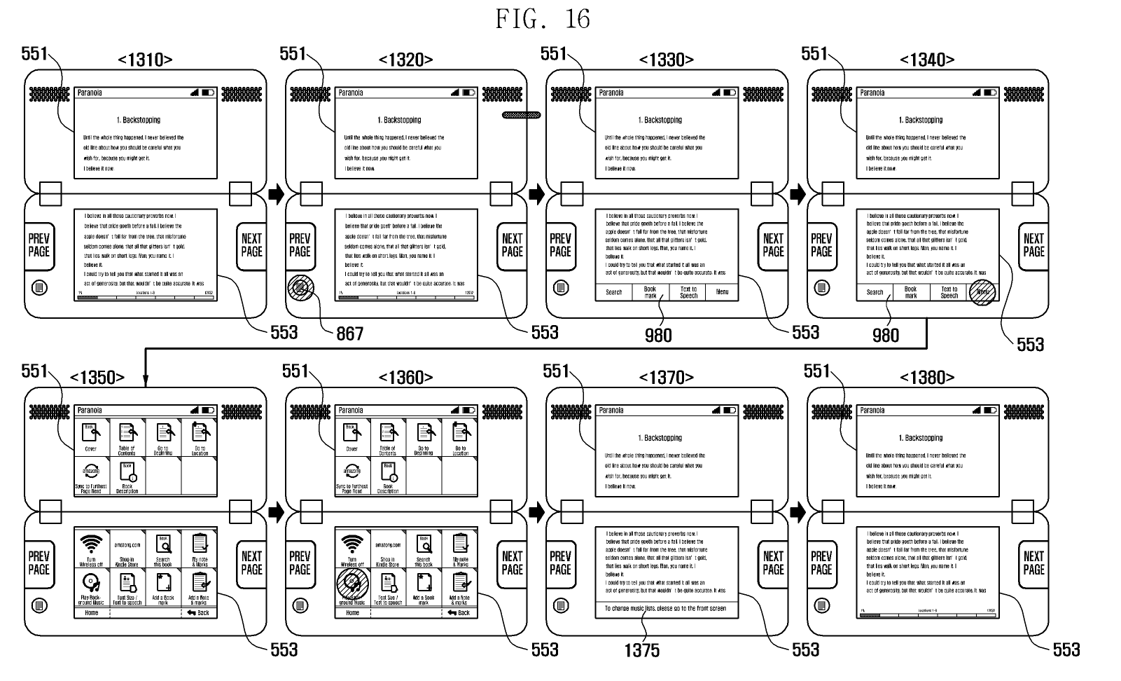

FIG. 15 depicts screen representations illustrating operations of a sub display in a mobile terminal according to an exemplary embodiment of the present invention.

Referring to FIG. 15, as depicted in presentation 1210, the control unit 580 of the mobile terminal may display screen data on the sub display 550 according to a user request. Here, the screen data may correspond to an electronic document that was displayed on the main display 540 according to selection of related update information and was resized to fit the sub display 550, or may correspond to screen data produced by executing an application (for example, connecting to a service server and downloading a web page) after opening the first body 100 and second body 200. For example, the screen data may be the same as the web page in presentation 1170 of FIG. 14. It is assumed in this example that presentation 1210 of FIG. 15 corresponds to presentation 1170 of FIG. 14 (i.e., the description of FIG. 15 begins with presentation 1170 of FIG. 14).

As depicted in presentation 1210, the user may generate a request event to switch the display style of the web page on the sub display 550 by, for example, double tapping a location of the upper sub display 551 or the lower sub display 553.

Upon detection of the double tap event, the control unit 580 switches the display style of the web page between the web view and the text view. For example, when the current display style is the web view, the control unit 580 switches the display style to the text view in response to the double tap event. When the current display style is the text view, the control unit 580 switches the display style to the web view in response to the double tap event. A web page may exemplarily be displayed as an HTML or XML-based document in the web view, and may exemplarily be displayed as a text-based document in the text view. In the following description of FIG. 15, the display style changes from the web view to the text view.

Hence, upon detection of the double tap event, the control unit 580 changes the display style of the web page from the web view as depicted in presentation 1210 to the text view as depicted in presentation 1220. Here, screen data in the text view may be composed of lines of text in the main frame of the web page, and font sizes may be adjusted according to display style switching.

For example, as indicated by the related information zone 1127 depicted in presentations 1210 and 1220, a 2-page document in the web view may be transformed into a 4-page document in the text view. That is, the control unit 580 may compose screen data according to the current display style.

The user may generate a request event to activate the option menu through the menu key 867 while the web page is displayed in the text view as depicted in presentation 1220 (or in the web view as depicted in presentation 1210). As depicted in presentation 1230, the control unit 580 replaces the base menu in the menu zone 980 with the option menu.

As depicted in presentation 1230, the user may make a gesture to invoke a desired function while the option menu is activated. For example, the user may make a gesture to highlight a word, sentence, or paragraph of the screen data on the sub display 550. This procedure is illustrated in presentations 1230 to 1260.

For example, as depicted in presentation 1230, the user may enter a gesture event like the left corner bracket [symbol] to indicate the beginning of the highlighted part. The control unit 580 places a mark like the left corner bracket at the location where the gesture event was entered. Here, the control unit 580 may output a sub option menu 1035 above the menu zone 980 on the lower sub display 553.

Thereafter, as depicted in presentation 1240, the user may enter a gesture event like the right corner bracket [symbol] to indicate the end of the highlighted part. The control unit 580 places a mark like the right corner bracket at the location where the gesture event was entered.

The user may select the “highlight” item of the sub option menu 1035 to issue a highlight command. The control unit 580 highlights the content section enclosed in the symbol like the left corner bracket and the symbol like the right corner bracket. The user may also control highlighting through a preset gesture without menu selection, as depicted in presentations 1250 and 1260.

For example, after marking the content section to be highlighted with symbols [symbol] and [symbol] as depicted in presentations 1230 and 1240, the user may enter a request event to highlight the content section enclosed in the symbols [symbol] and [symbol] by making a preset gesture (for example, a check mark gesture like [symbol] ). Then, the control unit 580 highlights the content section enclosed in the symbols [symbol] and [symbol] as depicted in presentation 1260.

After highlighting the content section, the control unit 580 may perform an operation according to a user request. For example, the control unit 580 may store the highlighted section in a preset storage area in a given file format (for example, txt or pdf) automatically or according to a user selection. Such storage based on user selection may be performed by selecting an item “highlight” or “note” of the sub option menu 1035 that may be accompanied by the “store” function.

When no user input is generated for longer than a preset time after highlighting, the control unit 580 may remove the sub option menu 1035 from the lower sub display 553 and deactivate the touch functionality of the sub display 550. In addition, the control unit 580 may turn off the sub display 550. Alternatively, after highlighting, the control unit 580 may automatically invoke a mail composition function to add the highlighted section to an electronic mail. Here, the highlighted section may be added to the electronic mail as body content through copying based on a clipping function or as a file attachment according to a user selection.

FIG. 16 depicts screen representations illustrating operations of a sub display in a mobile terminal according to an exemplary embodiment of the present invention.

Referring to FIG. 16, as depicted in presentation 1310, the control unit 580 of the mobile terminal may display screen data on the sub display 550 according to a user request. Here, the screen data may correspond to an electronic document that was displayed on the main display 540 according to selection of related update information and was resized to fit the sub display 550, or may correspond to screen data produced by executing a function (such as viewing a stored electronic book) after opening the first body 100 and second body 200. As depicted in presentation 1310, the menu zone 980 and the base menu may be not displayed on the sub display 550 according to the type of screen data or settings.

As depicted in presentation 1320, the user may generate an input signal for activating the option menu through the menu key 867 while screen data is displayed as depicted in presentation 1310. Then, the control unit 580 regards the input signal generated by the menu key 867 as a request event for activating the option menu, and outputs the option menu in the menu zone 980 as depicted in presentation 1330.

The user may execute one of various functions using the option menu while the option menu is activated as depicted in presentation 1330. As an example, the description of FIG. 16 may relate to playback of background music while screen data is displayed on the sub display 550.

As depicted in presentation 1340, the user may select a “menu” item of the option menu in the menu zone 980. As depicted in presentation 1350, the control unit 580 may output a UI screen having preset items associated with various functions on the upper sub display 551 and the lower sub display 553.

Here, although both of the upper sub display 551 and the lower sub display 553 are used to display the items depicted in presentation 1350, one of the upper sub display 551 and the lower sub display 553 may be used to display the items according to the number of items. For example, when the number of items is eight, the screen data may be kept on the upper sub display 551 and the eight items may be displayed on the lower sub display 553.

As depicted in presentation 1360, the user may generate a request event to select an item for background music playback by tapping the item. The control unit 580 identifies the function associated with the tapped item.

When the associated function is background music playback, the control unit 580 extracts an audio file specified for background music, starts to play back the audio file in the background, and outputs the resulting audio signal to the speaker at the first body 100. Here, as depicted in presentation 1370, the control unit 580 may recover the original screen data on the sub display 550 after starting background music playback.

As depicted in presentation 1370, the control unit 580 may provide information related to background music for a preset time through a popup window 1375. For example, the control unit 580 may provide guide information for creating a list of background music or information related to the currently played music such as file name, title, and artist. Hence, the user may select background music or set a background music list through the main display 540 after closing the first body 100 and the second body 200. Alternatively, the user may extract a background music list, select background music, or update the list by tapping the popup window 1375.

When no request event related to background music playback is generated for longer than a preset time after outputting the popup window 1375 as depicted in presentation 1370, the control unit 580 may remove the popup window 1375 as depicted in presentation 1380. Thereafter, when a mode transition interaction, such as a body closing interaction is detected during playing back background music, the control unit 580 may terminate playback of background music or continue playback of background music in the regular mode according to settings. Such settings may be changed by the user.

Although not shown in FIG. 16, the control unit 580 may execute a function associated with one of the items selected by a request event on the sub display 550. For example, when a request event is generated by the user to select an item associated with e-book purchasing in presentation 1350, the control unit 580 may connect to a service server indicated by the selected item, output a purchase handling screen on the sub display 550, and perform subsequent transaction operations according to user requests. In this procedure, the control unit 580 may display various screen data on the sub display 550.

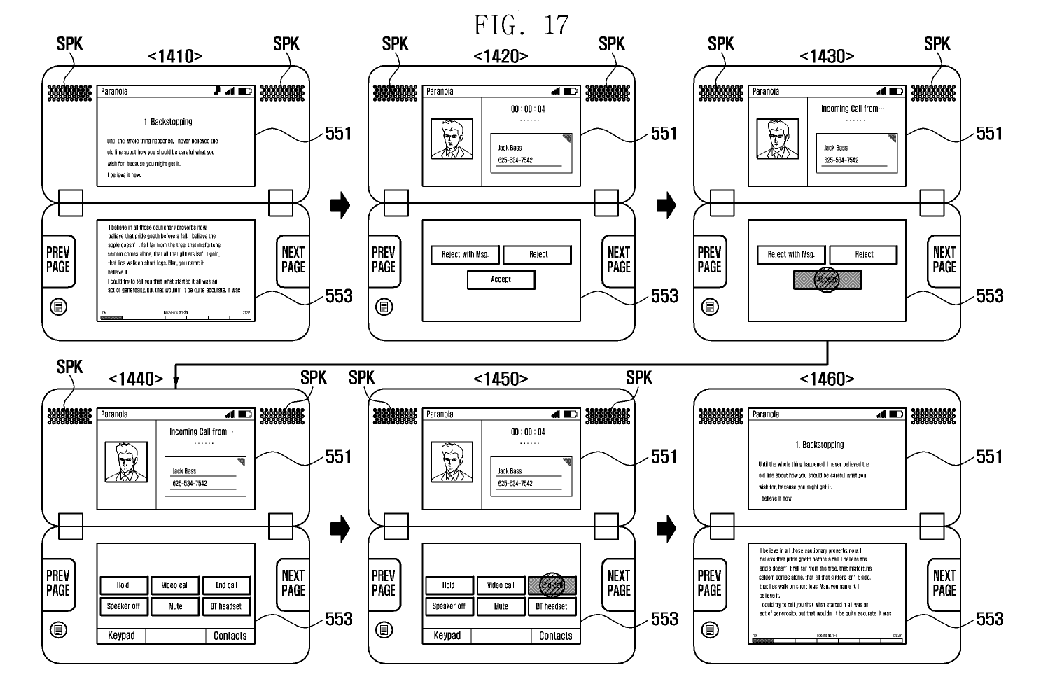

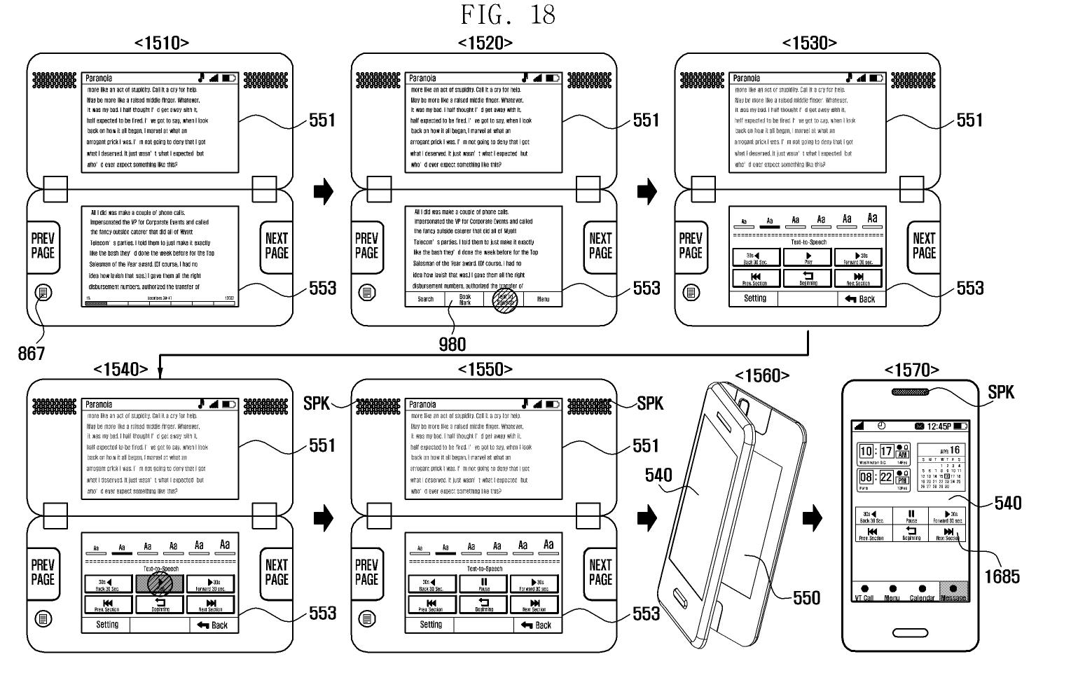

FIG. 17 depicts screen representations illustrating operations of a sub display in a mobile terminal according to an exemplary embodiment of the present invention.

Referring to FIG. 17, as depicted in presentation 1410, the control unit 580 of the mobile terminal may display screen data on the sub display 550 according to a user request. Here, the screen data may correspond to an electronic document that was displayed on the main display 540 according to selection of related update information and was resized to fit the sub display 550, or may correspond to screen data produced by executing a function (such as viewing a stored electronic book) after opening the first body 100 and second body 200. As depicted in presentation 1410, the menu zone 980 and the base menu may be not displayed on the sub display 550 according to the type of screen data or settings.

The user may receive a call from a counterpart while reading the screen data on the sub display 550 as depicted in presentation 1410. Upon arrival of an incoming call during screen data display on the sub display 550, the control unit 580 may output a preset ring tone through the speaker SPK and display a call handling screen on the sub display 550 as depicted in presentation 1420. Here, the control unit 580 may control screen transition.

As depicted in presentation 1420, upon arrival of an incoming call, the control unit 580 may identify the phone number of the caller, search the phonebook stored in the storage unit 570 for the identified phone number, extract information related to the phone number from the phonebook, and output the extracted information on the upper sub display 551. For example, caller's photograph, name and phone number, and call status information may be output. If the phone number of the caller is not found in the phonebook, the identified phone number alone may be output.

As depicted in presentation 1420, the control unit 580 may output buttons enabling the user to control the incoming call on the lower sub display 553. Such buttons may include a button for rejecting the call and sending a rejection message, a button for rejecting the call without sending the rejection message, and a button for accepting the call.

The user is made aware of arrival of an incoming call through the call handling screen on the sub display 550, and may decide to accept or reject the call by entering the corresponding button. For example, as depicted in presentation 1430, the user may accept the call by entering the corresponding button. The control unit 580 may regard the input signal generated by the accepting button as a request event accepting the call, establish a call connection to the caller mobile terminal, and output a call connection screen after connection establishment as depicted in presentation 1440.

As depicted in presentation 1440, the control unit 580 may activate a timer when the button for accepting the call is entered and output the talk time as status information on the upper sub display 551. In addition, the control unit 580 may provide various buttons for call handling during the call on the lower sub display 553. Such buttons may include buttons for “hold”, “video call”, “end call”, “speaker off”, “mute”, and “BT headset” (for Bluetooth connection).

In the course of the call, the user may enter one of the buttons to control the call. For example, the user may migrate from the incoming call to a video call, put the incoming call on hold, or end the incoming call. As depicted in presentation 1450, the user may enter the “end call” button to end the call, in which case the control unit 580 terminates the call. Here, call termination may be triggered by the caller mobile terminal.

As depicted in presentation 1460, the control unit 580 may restore the previous screen data on the sub display 550 after ending the call. That is, the control unit 580 may control screen transition from the call handling screen to the previous screen.

Although not shown in FIG. 17, when an incoming call arrives while operating the sub display 550, the control unit 580 may initiate one of speakerphone conversation, headset conversation, and conversation after transitioning to the regular mode according to settings. The control unit 580 may process a voice signal of the user collected by the microphone MIC at the first body 100 during call handling.

FIG. 18 depicts screen representations illustrating operations of a sub display in a mobile terminal according to an exemplary embodiment of the present invention.

Referring to FIG. 18, as depicted in presentation 1510, the control unit 580 of the mobile terminal may display screen data on the sub display 550 according to a user request. Here, the screen data may correspond to an electronic document that was displayed on the main display 540 according to selection of related update information and was resized to fit the sub display 550, or may correspond to screen data produced by executing a function (such as viewing a stored electronic book) after opening the first body 100 and second body 200. As depicted in presentation 1510, the menu zone 980 and the base menu may be not displayed on the sub display 550 according to the type of screen data or settings.

The user may generate an input signal for activating the option menu through the menu key 867 while screen data is displayed as depicted in presentation 1510. Then, the control unit 580 regards the input signal generated by the menu key 867 as a request event for activating the option menu, and outputs the option menu in the menu zone 980 as depicted in presentation 1520.

The user may execute one of various functions using the option menu while the option menu is activated as depicted in presentation 1520. As an example, the description of FIG. 18 relates to execution of a TTS (Text To Speech) function on the basis of screen data on the sub display 550.

As depicted in presentation 1520, the user may select a “Text To Speech” item of the option menu in the menu zone 980. As depicted in presentation 1530, the control unit 580 may output a UI screen having preset items for controlling the TTS function on the lower sub display 553. Here, the screen data may be kept on the upper sub display 551 and the UI screen having preset items for controlling the TTS function may be displayed on the lower sub display 553.

As depicted in presentation 1540, the user may generate a request event to select an item for TTS execution by tapping the item. The control unit 580 identifies the function associated with the tapped item, and executes the TTS function as depicted in presentation 1550 and outputs the resulting audio signal to the speaker SPK at the first body 100. Here, the screen data may be converted into sounds from the beginning thereof on the upper sub display 551. The user may control execution of the TTS function using the control items, such as, for example, “backward 30 seconds and play,” “forward 30 seconds and play,” “pause,” “previous section,” “back to beginning,” and “next section.”

As depicted in presentation 1560, the user may close the first body 100 and the second body 200 during TTS execution. That is, the mobile terminal transitions from the special mode to the regular mode. The control unit 580 operates the main display 540, displays the idle screen on the main display 540, and stops operation of the sub display 550. Here, as depicted in presentation 1570, the control unit 580 may provide a TTS control window 1685 together with the idle screen. That is, when a mode transition interaction such as a body closing interaction is detected during TTS execution through the sub display 550, the control unit 580 operates the main display 540, stops operation of the sub display 550, displays the TTS control window 1685 on the main display 540, and outputs the audio signal resulting from the TTS function to the speaker SPK.

Hence, even when the mobile terminal transitions to the regular mode while the TTS function is being executed on the basis of screen data on the sub display 550, the user may control execution of the TTS function using the TTS control window 1685 provided on the main display 540 with the terminal body closed.

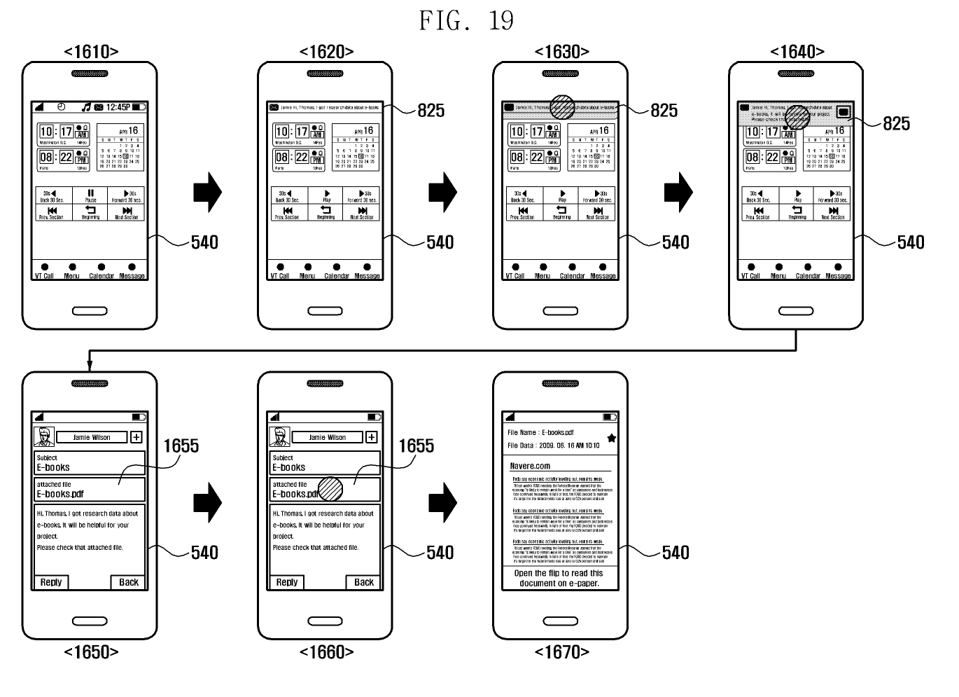

FIG. 19 depicts screen representations illustrating operations of a mobile terminal according to an exemplary embodiment of the present invention.

The description of FIG. 19 may be related to that of FIGS. 8 to 11. In FIG. 19, starting from an initial state depicted in presentation 1610, an e-mail is used as an electronic document, and a notification of arrival of a new e-mail is provided as update information in the update information zone 825 and screen data corresponding to the newly received e-mail is displayed on the main display 540 as depicted in presentation 1620.

As depicted in presentation 1630, the user generates a first request event by dragging the update information zone 825, and the control unit 580 enlarges the update information zone 825. As depicted in presentation 1640, the user generates a second request event by tapping the update information zone 825, and the control unit 580 displays the new e-mail on the main display 540 as depicted in presentation 1650. When the e-mail has an attached file, an attachment field 1655 is provided. As depicted in presentation 1660, the user generates a third request event by tapping the attachment field 1655, and the control unit 580 retrieves the attached file and displays the same on the main display 540 as depicted in presentation 1670. Here, the exemplary attached file is a Portable Document Format (PDF) file.

The user may open the first body 100 and the second body 200 in a state of presentation 1650 or presentation 1670 to read the e-mail or the attached file on the basis of the sub display 550 and to execute functions related thereto.

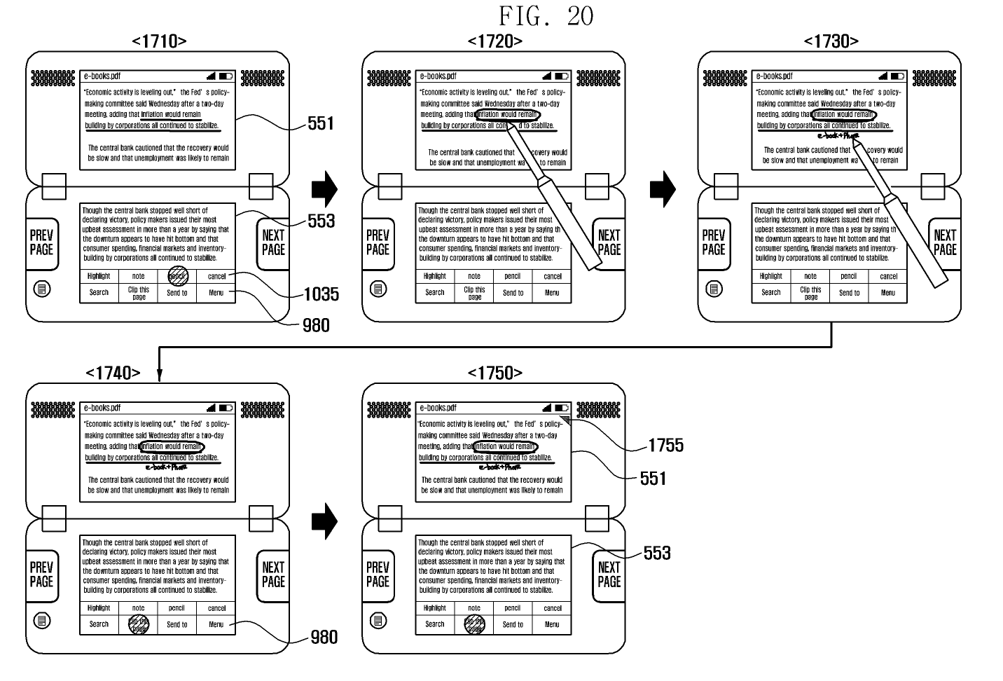

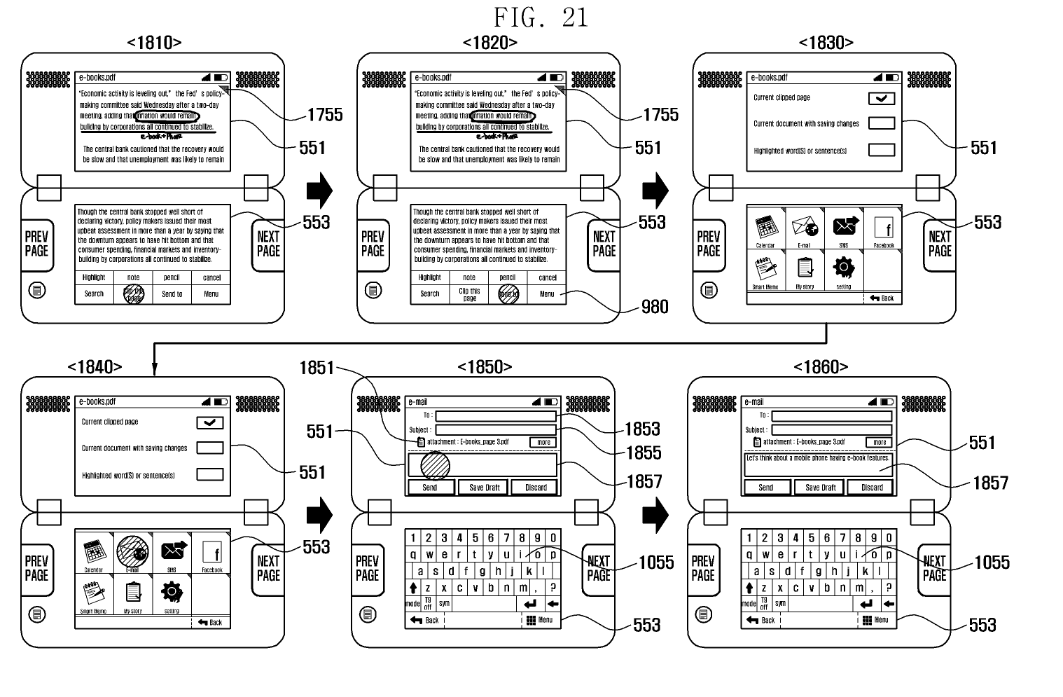

FIG. 20 depicts screen representations illustrating operations of a sub display in a mobile terminal according to an exemplary embodiment of the present invention.

Referring to FIG. 20, as depicted in presentation 1710, the user may underline words or sentences of screen data according to the procedure of FIG. 13 and activate a sub option menu 1035. The user may control execution of various functions using the option menu in the menu zone 980 and the sub option menu 1035. As an example, the description of FIG. 20 relates to functions related to a “pencil” item and “clip this page” item.

As depicted in presentation 1710, the user may generate a request event to select a “pencil” item of the sub option menu 1035. Upon detection of the request event, the control unit 580 activates the function associated with the “pencil” item as depicted in presentation 1720. The user may make a gesture to mark words or input characters as depicted in presentations 1720 to 1730. For example, in presentation 1720, the user puts a mark on selected words by making a drawing gesture. In presentation 1730, the user enters characters (for example, “e-book+phone”) by making a writing gesture.

As depicted in presentation 1740, the user may select a “clip this page” item in the menu zone 980. The control unit 580 may clip the screen data corrected by user gestures, and buffer the clipped screen data or store the same as a separate file according to a user selection. As depicted in presentation 1750, the control unit 580 may also output a clipping mark 1755 on the sub display 550 to indicate clipping of the screen data with user corrections. Thereafter, as depicted in presentation 1830 of FIG. 21, the control unit 580 may add the clipped screen data to an e-mail as a file attachment and send the electronic mail to the recipient according to request events generated by the user. This is further described later.

FIG. 21 depicts screen representations illustrating operations of a sub display in a mobile terminal according to an exemplary embodiment of the present invention.

Referring to FIG. 21, as depicted in presentation 1810, the control unit 580 of the mobile terminal may clip the screen data on the sub display 550 according to a procedure of FIG. 20 and buffer the clipped screen data or store the same according to a user selection.

As depicted in presentation 1820, the user may select a “send to” item in the menu zone 980 to send an e-mail. Upon detection of a user request generated by the “send to” item, the control unit 580 may output a transmission related screen as depicted in presentation 1830. For example, the control unit 580 may provide items for specifying an object to be sent on the upper sub display 551, and provide functional items associated with transmission options on the lower sub display 553. The transmission options may exemplarily be related to a message, an e-mail, a calendar, a social networking site (such as “Facebook”), a memo, a story, or settings.

As the object to be sent is set to the clipped screen data previously depicted in presentation 1820, the control unit 580 may automatically put a check mark on the “current clipped page” item on the upper sub display 551 as depicted in presentation 1830.

As depicted in presentation 1840, the user may select an “E-mail” item on the lower sub display 553 to send an e-mail. The control unit 580 may provide a mail composition screen on the sub display 550 as depicted in presentation 1850. For example, the control unit 580 may provide fields for mail composition on the upper sub display 551 and display a virtual keypad 1055 on the lower sub display 553.

The control unit 580 may automatically enter the name of the attached file containing the clipped screen data in a file attachment field 1851 on the upper sub display 551. For example, the control unit 580 may buffer the clipped screen data or store the same as a file of a given type. Later, when the e-mail function is executed, the control unit 580 may convert the buffered screen data into a file of a given type (such as a PDF file) and attach the file to the e-mail or may attach the pre-stored file to the e-mail.

The user may enter the recipient's address, the subject, and the body contents in input fields 1853, 1855 and 1857 on the upper sub display 551. For example, as depicted in presentation 1850, the user may select the input field 1857 to compose the message body. The control unit 580 may activate the selected input field 1857 and wait for user inputs.

After activation of the input field 1857, the user enters characters using the virtual keypad 1055 on the lower sub display 553 to compose the message body. The control unit 580 may display the entered characters and add the same to the message body. After entering the recipient address and subject, the user may send the composed e-mail.

As described above, the user may select words (or sentences) of the screen data on the sub display 550 by making preset gestures or clip a page of the screen data on the sub display 550, and send the selected words or the clipped page using an e-mail, memo, message, or calendar function. For example, the selected words may be automatically added to the body of an electronic mail, and the clipped page may be added to the electronic mail as a file attachment. Alternatively, the selected words may be converted into a file of a given type and the file may be added to the e-mail as an attachment according to user settings or selections.

Hereinabove, exemplary embodiments of the present invention are described using the mobile terminal having a single control unit as shown in FIG. 7. However, the mobile terminal of the present invention may have more than one control unit. For example, the mobile terminal may include a main control unit to control operations related to the main display 540 in the regular mode and a sub control unit to control operations related to the sub display 550 in the special mode, and may support the function of the present invention through coordinated operations of the main control unit and the sub control unit. In this case, a sub control unit may be added to the configuration in FIG. 7. The mobile terminal may further include Dual-Port RAM (DPRAM) for inter-processor communication between the main control unit and sub control unit.

According to exemplary embodiments of the present invention, providing a method and apparatus that operate a mobile terminal having at least two display units, the mobile terminal may present screen data such as electronic documents in an organized way through coordinated operations of the main display supporting the regular mode and the sub display supporting the special mode. The mobile terminal may readily transition between the regular mode and the special mode according to user interactions. The user may read an electronic document on the sub display in a more intuitive and convenient manner after transitioning to the special mode. Hence, the user may readily access and utilize electronic documents through the mobile terminal. In addition, while an electronic document is displayed on the sub display in the special mode, the user may execute various functions using the current screen data by generating request events.

The above-described methods according to exemplary embodiments of the present invention can be realized in hardware or as software or computer code that can be stored in a recording medium such as a Compact Disk ROM (CD ROM), an RAM, a floppy disk, a hard disk, or a magneto-optical disk or downloaded over a network, so that the methods described herein can be rendered in such software using a general purpose computer, or a special processor or in programmable or dedicated hardware, such as an Application-Specific Integrated Circuit (ASIC) or Field-Programmable Gate Array (FPGA). As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

What is claimed is:

1. A display unit for a mobile terminal, the display unit comprising:
a first display for displaying screen data related to a function executed in a first mode of the mobile terminal; and
a second display for displaying screen data related to a function executed in a second mode of the mobile terminal, and for displaying, after transitioning from the first mode to the second mode, the screen data having been displayed on the first display in a continuous manner.

2. The display unit of claim 1, wherein the second display is divided into at least two display sections and the display sections operate as a single entity to display a single piece of screen data or as multiple entities to display different pieces of screen data.

3. A method of operating a mobile terminal, the method comprising:
displaying screen data of an electronic document on a first display according to a user request;
transforming, upon detection of a mode transition interaction, the screen data of the electronic document displayed on the first display; and
displaying the transformed screen data of the electronic document on a second display.

4. The method of claim 3, wherein the displaying of the screen data on the first display comprises outputting update information in response to an update interaction in a first mode, and displaying screen data of an electronic document related to the update information on the first display in response to a user request for the update information.

5. The method of claim 4, further comprising transitioning from the first mode to a second mode upon detection of the mode transition interaction.

6. The method of claim 4, wherein the transforming of the screen data comprises transforming the screen data displayed on the first display so as to meet specifications of the second display.

7. The method of claim 4, further comprising turning off, after detection of the mode transition interaction, the first display and operating the second display.

8. The method of claim 7, wherein the mode transition interaction comprises a user interaction requesting transition from the first mode to the second mode, and is generated by one of opening a body of the mobile terminal, entering a physical transition key, entering a soft transition key, recognizing a voice signal, and recognizing a motion or state of the mobile terminal.

9. The method of claim 3, further comprising controlling execution of a function selected by a user gesture after displaying the screen data on the second display.

10. The method of claim 9, further comprising:
transforming, upon detection of a mode transition interaction after displaying the screen data on the second display, the screen data of the electronic document displayed on the second display; and
displaying the transformed screen data of the electronic document on the first display.

11. The method of claim 10, further comprising determining, upon detection of the mode transition interaction, a transition scheme for display operation using the first display.

12. The method of claim 11, wherein the mode transition interaction comprises a user interaction requesting a transition from the second mode to the first mode, and is generated by one of closing a body of the mobile terminal, entering a physical transition key, entering a soft transition key, recognizing a voice signal, and recognizing a motion or state of the mobile terminal.

13. A mobile terminal comprising:
a display means comprising at least two displays that are separately operable; and
a control unit for specifying one of the at least two displays as a first display supporting a first mode, for specifying another one of the at least two displays as a second display supporting a second mode, and for controlling the first display and second display to display screen data through coordinated operations thereof.

14. The mobile terminal of claim 13, wherein the second display is divided into at least two display sections, and wherein the control unit controls the display sections to operate as a single entity to display a single piece of screen data or as multiple entities to display different pieces of screen data.

15. The mobile terminal of claim 14, wherein the control unit transforms, upon detection of a mode transition interaction, screen data displayed on the first display so as to meet specifications of the second display and controls the second display to display the transformed screen data.
